(19) United States
(12) Patent Application Publication
(10) Pub. No.: US 2026/0134037 A1
(43) Pub. Date: May 14, 2026

(54) METHOD, APPARATUS AND SYSTEM FOR SEMANTIC COMMUNICATIONS

(71) Applicant: Huawei Technologies Co., Ltd., Shenzhen (CN)

(72) Inventors: Yiqun Ge, Ottawa (CA); Mengyao Ma, Shenzhen (CN); Jianglei Ma, Ottawa (CA); Qifan Zhang, Kanata (CA)

(21) Appl. No.: 19/425,468

(22) Filed: Dec. 18, 2025

Related U.S. Application Data
(63) Continuation of application No. PCT/CN2023/128915, filed on Oct. 31, 2023.
(60) Provisional application No. 63/509,464, filed on Jun. 21, 2023.

(51) Int. Cl. G06F 16/903

(52) U.S. Cl. CPC G06F 16/90335

(57) ABSTRACT

Provided are a method and related products for semantic communications. The method includes: determining whether sensed data and first query information are matched; and transmitting a sensing result to a central device when the sensed data and the first query information are matched, where the sensing result indicates the sensed data. The transmission of the sensing result which indicates the sensed data is triggered in the case that the sensed data and the first query information are matched.

### CROSS-REFERENCE TO RELATED APPLICATIONS

This application is a continuation of International Application No. PCT/CN 2023/128915, filed on Oct. 31, 2023, which claims priority to U.S. Provisional Patent Application No. 63/509,464 , filed on Jun. 21, 2023, applications of which are hereby incorporated by reference in their entireties.

### TECHNICAL FIELD

The present disclosure relates generally to the field of communication technologies and, in particular, to a communication method, a communication apparatus, a communication system and related products.

### BACKGROUND

A sensing function will be integrated into a 6th generation (6G) system. A large number of sensing user equipments (UEs) or sensing devices will be densely deployed in cities, factories, farms and so on. In addition to mobile phones, sensing devices will become an important type of UEs or devices that claim an arrival of internet of thing (IoT) time. Like internet searching engines, 6G will come up with the counterpart, an IoT searching engine, in a true physical world. In fact, billions of IoT-based applications such as driverless cars, automation factories, smart cities, autonomous farms, will heavily depend on an efficient and real-time searching engine in the physical world.

Recently, artificial intelligence (AI) has conquered various intellectual and cognitive domains. Some AI is exploring the cutting edge of intellectual knowledge in chemistry, gaming, mathematics, gene engineering; while some other AI is providing a human-level Q&A platform in the digital world. The domain that AI has not conquered is the real-time physical world. Physical-world AI, in which AI technologies are to penetrate into all aspects of the society and life, may be built on omnipresent IoT connections thanks to 6G.

More challenging than internet searching engines, a real-world searching engine would have to search the physical world in real time over a large scale of physical area and to deal with a multitude of types of data and information. Furthermore, green technology, low-energy and low-emission, are also raised as key features of 6G. A sensing device may be battery powered and/or completely powered by solar and wind. In some implementations, a sensing device may be a UE, a mobile phone or a handset, where independence among any two sensing devices are assumed; thereby, a sensing device may be scheduled individually by a wireless system to which the sensing device is associated; and sensed data that the sensing device measures may be application-level payload for the wireless system and protocol. The above scheme of scheduling a sensing device is inefficient in terms of radio bandwidth and energy consumption.

This background information is provided to reveal information believed by the applicant to be of possible relevance to the present application. No admission is necessarily intended, nor should it be construed, that any of the preceding information constitutes prior art against the present application.

### SUMMARY

In a first aspect, a communication method is provided in the present disclosure, and the method includes:
determining whether sensed data and first query information are matched; and
transmitting a sensing result to a central device when the sensed data and the first query information are matched, where the sensing result indicates the sensed data.

The transmission of the sensing result which indicates the sensed data is triggered in the case that the sensed data and the first query information are matched, that is, the transmission of the sensing result has a specific condition, and the sensing result is not transmitted all the time, thus the transmission resources are saved; in addition, the transmitted sensing result meets the requirement of the first query information, that is, irrelevant information is filtered, the transmitted data is what the central device requires, responding accuracy is thus ensured.

In a possible implementation of the first aspect, the method further includes: receiving the first query information from the central device.

The first query information from the central device wakes a sensing device to measure and transmit the sensing result when the sensed data and the first query information are matched, that is, the sensing device starts the computation of the matching determination in response to the first query information, and may not start the computation of the matching determination under other circumstances, the energy consumption for the sensing device is thus reduced.

In a possible implementation of the first aspect, the receiving the first query information from the central device includes: receiving the first query information broadcasted or multicasted by the central device.

The received first query information is broadcasted or multicasted by the central device, thus, the first query information can be transmitted to a plurality of sensing devices, the transmission efficiency of the first query information is thus improved.

In a possible implementation of the first aspect, the first query information includes a query message; the method further includes:
obtaining the sensed data;
the determining whether the sensed data and the first query information are matched includes:
determining whether the sensed data and the query message are matched.

The sensed data is in a form of natural language, in the case that the first query information is in a form of a query message, i.e., also in a form of natural language, since the comparing objects are in the same form, the sensed data and the query message can be directly compared to determine whether the sensed data and the query message are matched or not. A simple and convenient manner to obtain a comparing result is thus provided.

In a possible implementation of the first aspect, the first query information includes a query message; the method further includes:
obtaining the sensed data;
translating the sensed data into a sensing semantic according to a semantization configuration;
translating the query message into a query semantic according to the semantization configuration;
the determining whether the sensed data and the first query information are matched includes:
determining whether the sensing semantic and the query semantic are matched.

In the case that both the sensed data and the first query information are in a form of natural language, they can be translated into the sensing semantic and the query semantic respectively, the translation of the sensed data and the query message are implemented according to the same semantization configuration, thus, the sensing semantic and the query semantic are in the same form, then the comparison is implemented between the sensing semantic and the query semantic. That is, both the sensed data and the query message are translated into a common semantic domain on which they can be easily compared to each other and fused. Since the form of semantic may provide more accurate true intentions, accuracy of a comparing result is thus improved.

In a possible implementation of the first aspect, the first query information includes a query semantic; the method further includes:
obtaining the sensed data;
translating the sensed data into a sensing semantic according to a semantization configuration;
the determining whether the sensed data and the first query information are matched includes:
determining whether the sensing semantic and the query semantic are matched.

In the case that the sensed data is in a form of natural language, while the first query information is in a form of semantic, the sensed data can be translated into the sensing semantic, then the comparison is implemented between the sensing semantic and the query semantic. That is, both the sensed data and the query information are in a common semantic domain on which they can be easily compared to each other and fused. A query semantic may preserve all the key semantic goals conveyed by the query message such that the query semantic can be well translated (de-semantized) back to a query message. Since the form of semantic may provide more accurate true intentions, accuracy of a comparing result is thus improved.

In a possible implementation of the first aspect, the first query information includes a query message; the method further includes:
obtaining the sensed data;
translating the sensed data into a sensing semantic according to a semantization configuration;
tokenizing the sensing semantic into a sensing token according to a tokenization configuration;
translating the query message into a query semantic according to the semantization configuration;
tokenizing the query semantic into a query token according to the tokenization configuration;
the determining whether the sensed data and the first query information are matched includes:
determining whether the sensing token and the query token are matched.
In the case that both the sensed data and the first query information are in a form of natural language, they can be processed into the sensing token and the query token respectively, the processing of the sensed data and the query message are implemented according to the same semantization configuration and the same tokenization configuration, thus, the sensing token and the query token are in the same form, then the comparison is implemented between the sensing token and the query token. Since the form of token may provide more accurate true intentions and save signaling overhead, accuracy of a comparing result is thus improved and signaling overhead is saved. Further, the tokenization can be used to prevent a sensing device from recovering a complete query message from a query token. The tokenization may come up with certain privacy protection for query messages.

In a possible implementation of the first aspect, the first query information includes a query semantic; the method further includes:
obtaining the sensed data;
translating the sensed data into a sensing semantic according to a semantization configuration;
tokenizing the sensing semantic into a sensing token according to a tokenization configuration;
tokenizing the query semantic into a query token according to the tokenization configuration;
the determining whether the sensed data and the first query information are matched includes:
determining whether the sensing token and the query token are matched.

In the case that the sensed data is in a form of natural language, while the first query information is in a form of semantic, the sensed data can be processed into the sensing token, and the query semantic can be processed into the query token, then the comparison is implemented between the sensing token and the query token. Since the form of token may provide more accurate true intentions and save signaling overhead, accuracy of a comparing result is thus improved and signaling overhead is saved. Further, the tokenization can be used to prevent a sensing device from recovering a complete query message from a query token. The tokenization may come up with certain privacy protection for query messages.

In a possible implementation of the first aspect, the first query information includes a query token; the method further includes:
obtaining the sensed data;
translating the sensed data into a sensing semantic according to a semantization configuration;
tokenizing the sensing semantic into a sensing token according to a tokenization configuration;
the determining whether the sensed data and the first query information are matched includes:
determining whether the sensing token and the query token are matched.
In the case that the sensed data is in a form of natural language, while the first query information is in a form of token, the sensed data can be processed into the sensing token, then the comparison is implemented between the sensing token and the query token. Since the form of token may provide more accurate true intentions and save signaling overhead, accuracy of a comparing result is thus improved and signaling overhead is saved. Further, the tokenization can be used to prevent a sensing device from recovering a complete query message from a query token. The tokenization may come up with certain privacy protection for query messages.

In a possible implementation of the first aspect, the method further includes:
determining a semantic length and a semantic format;
the translating the sensed data into the sensing semantic according to the semantization configuration includes:
translating the sensed data into the sensing semantic with the semantic length and the semantic format according to the semantization configuration.

There may be different semantic lengths and different semantic formats for different kinds of sensed data, an appropriate semantic length and an appropriate semantic format are determined for the specific kind of sensed data, then the specific kind of sensed data is translated into the sensing semantic with the semantic length and the semantic format according to the semantization configuration, thereby ensuring high efficiency of data processing.

In a possible implementation of the first aspect, the method further includes:
obtaining an identifier of the semantization configuration;
the translating the sensed data into the sensing semantic according to the semantization configuration includes:
translating the sensed data into the sensing semantic according to the semantization configuration with the obtained identifier.

There may be different semantization configurations for different kinds of sensed data, an identifier of an appropriate semantization configuration is obtained for the specific kind of sensed data, then the specific kind of sensed data is translated into the sensing semantic according to the semantization configuration with the obtained identifier, thereby ensuring high efficiency of data processing.

In a possible implementation of the first aspect, the obtaining the identifier of the semantization configuration includes:
obtaining a predefined identifier of the semantization configuration, or
receiving an identifier of the semantization configuration from the central device.

The identifier of the semantization configuration may be predefined, or may be transmitted to the sensing device from the central device, which provides more flexibility and can thus meet different requirements.

In a possible implementation of the first aspect, the method further includes:
determining a token length according to a length of the query token;
the tokenizing the sensing semantic into the sensing token according to the tokenization configuration includes:
tokenizing the sensing semantic into a sensing token with the token length according to the tokenization configuration.

The token length of the sensing token is related to the length of the query token, which provides a convenient and fast comparison between the sensing token and the query token, thereby ensuring high efficiency of data processing.

In a possible implementation of the first aspect, the method further includes:
obtaining an identifier of the tokenization configuration;
the tokenizing the sensing semantic into the sensing token according to the tokenization configuration includes:
tokenizing the sensing semantic into the sensing token according to the tokenization configuration with the obtained identifier.

There may be different tokenization configurations for different kinds of sensing semantic, an identifier of an appropriate tokenization configuration is obtained for the specific kind of sensing semantic, then the specific kind of sensing semantic is processed into the sensing token according to the tokenization configuration with the obtained identifier, thereby ensuring high efficiency of data processing.

In a possible implementation of the first aspect, the obtaining the identifier of the tokenization configuration includes:
obtaining a predefined identifier of the tokenization configuration, or
receiving an identifier of the tokenization configuration from the central device.

The identifier of the tokenization configuration may be predefined, or may be transmitted to the sensing device from the central device, which provides more flexibility and can thus meet different requirements.

In a possible implementation of the first aspect, the tokenization configuration includes one of:
a tokenization model;
a tokenization function;
a projection matrix;
a graph-based or topology-based pruning; or
a compression approach.

There are a plurality of tokenization configurations to be chosen, which provides more flexibility and can thus meet different requirements.

In a possible implementation of the first aspect, the determining whether the sensed data and the first query information are matched includes:
determining whether a first matching score between the sensed data and the first query information is greater than or equal to a first threshold; or
determining whether a first distance between the sensed data and the first query information is less than or equal to a second threshold.

The sensed data and the first query information are matched or not can be implemented based on a first matching score between the sensed data and the first query information, or a first distance between the sensed data and the first query information, which provides an efficient implementation. It should be noted that other metrics such as the score of relevance between the sensed data and the first query information or the similarity between the sensed data and the first query information can also be used to indicate whether the sensed data and the first query information are matched or not.

In a possible implementation of the first aspect, the method further includes:
obtaining at least one of a scoring function for determining the first matching score, the first threshold, a function for determining the first distance, or the second threshold.

The first matching score between the sensed data and the first query information can be computed through a scoring function, the first distance between the sensed data and the first query information can be computed through a corresponding function, which provides an efficient implementation.

In a possible implementation of the first aspect, the obtaining at least one of the scoring function for determining the first matching score, the first threshold, the function for determining the first distance, or the second threshold includes:
obtaining at least one of the scoring function for determining the first matching score, the first threshold, the function for determining the first distance, or the second threshold that are predefined, or
receiving at least one of the scoring function for determining the first matching score, the first threshold, the function for determining the first distance, or the second threshold from the central device.

At least one of the scoring function for determining the first matching score, the first threshold, the function for determining the first distance, the second threshold may be predefined, or may be transmitted to the sensing device from the central device, which provides more flexibility and can thus meet different requirements.

In a possible implementation of the first aspect, the receiving the first query information from the central device includes: receiving the first query information along with at least one of the scoring function for determining the first matching score, the first threshold, the function for determining the first distance, or the second threshold, from the central device.

At least one of the scoring function for determining the first matching score, the first threshold, the function for determining the first distance, the second threshold may be transmitted to the sensing device from the central device along with the first query information, which provides more flexibility and can thus meet different requirements.

In a possible implementation of the first aspect, the scoring function includes an inner product, or a euclidean distance; and the function for determining the first distance includes an inner product, a cross-correlation matrix, or a cross-entropy function.

The scoring function may be in a form of an inner product, or a euclidean distance, the function for determining the first distance may be in a form of an inner product, a cross-correlation matrix, or a cross-entropy function, that is, the function can be implemented through various methods, which provides more flexibility and can thus meet different requirements.

In a possible implementation of the first aspect, the sensing result includes one of the following:
raw sensed data;
a sensing semantic obtained from raw sensed data;
half raw sensed data and a sensing semantic obtained from raw sensed data;
raw sensed data and a first matching score between the sensed data and the first query information;
raw sensed data and a first distance between the sensed data and the first query information;
a sensing semantic obtained from raw sensed data and a first matching score between the sensed data and the first query information;
a sensing semantic obtained from raw sensed data and a first distance between the sensed data and the first query information;
half raw sensed data, a sensing semantic obtained from raw sensed data, and a first matching score between the sensed data and the first query information;
half raw sensed data, a sensing semantic obtained from raw sensed data, and a first distance between the sensed data and the first query information.

The sensing result may be in various forms related to the sensed data, which provides more flexibility and can thus meet different requirements.

In a possible implementation of the first aspect, the first query information is carried in higher layer signaling or physical layer signaling or a combination of higher layer signaling and physical signaling, where the higher layer signaling includes one of radio resource control (RRC) signaling, medium access control (MAC) layer signaling, and the physical layer signaling includes downlink control information (DCI).

The first query information can be transmitted to the sensing device from the central device through specific signaling, which ensures high security and efficiency of data transmission.

In a possible implementation of the first aspect, the sensing result transmitted to the central device is carried in higher layer signaling or physical layer signaling or a combination of higher layer signaling and physical signaling, where the higher layer signaling includes one of radio resource control (RRC) signaling, medium access control (MAC) layer signaling, and the physical layer signaling includes uplink control information (UCI).

The sensing result can be transmitted to the central device from the sensing device through specific signaling, which ensures high security and efficiency of data transmission.

In a possible implementation of the first aspect, the transmitting the sensing result to the central device includes:
transmitting the sensing result to the central device in a physical uplink shared channel or a dedicated uplink channel.

The sensing result can be transmitted to the central device from the sensing device through a specific channel, which ensures high security and efficiency of data transmission.

In a second aspect, a communication method is provided in the present disclosure, and the method includes:
receiving a sensing result from a sensing device, where sensed data of the sensing device and first query information for the sensing device are matched, and the sensing result indicates the sensed data.

A central device receives the sensing result which indicates the sensed data in the case that the sensed data and the first query information are matched, the received sensing result meets the requirement of the first query information, that is, irrelevant information is filtered, the received data is what the central device requires, accuracy of data transmission is thus ensured.

In a possible implementation of the second aspect, the method further includes:
transmitting the first query information to the sensing device.

In a possible implementation of the second aspect, the transmitting the first query information to the sensing device includes:
broadcasting or multicasting the first query information to a plurality of sensing devices.

The first query information can be transmitted to a plurality of sensing devices, the transmission efficiency of the first query information is thus improved.

In a possible implementation of the second aspect, the method further includes:
receiving second query information from a generative pre-trained transformer (GPT) device;
outputting the sensing result to the GPT device.

The central device receives the second query information from the GPT device, transmits the first query information to the sensing device, then receives the sensing result from the sensing device, and outputs the sensing result to the GPT device, the central device serves as a bridge between the sensing device and the GPT device, thereby assisting in smooth communication between the sensing device and the GPT device.

In a possible implementation of the second aspect, both the first query information and the second query information include a query message.

In response to the received second query information in a form of a query message from the GPT device, the central device directly transmits the first query information in a form of a query message to the sensing device for subsequent processing, a simple and convenient transmission manner for the first query information is thus provided.

In a possible implementation of the second aspect, the second query information includes a query message; the method further includes:
translating the query message into a query semantic according to a semantization configuration;
the transmitting the first query information to the sensing device includes:
transmitting the query semantic to the sensing device.

The query content transmitted to the sensing device can be in a form of a query semantic, which enriches the form of the first query information, in addition, the form of semantic may provide more accurate true intentions. The query semantic may preserve all the key semantic goals conveyed by the query message such that the query semantic can be well translated (de-semantized) back to a query message.

In a possible implementation of the second aspect, the second query information includes a query message; the method further includes:
translating the query message into a query semantic according to a semantization configuration;
tokenizing the query semantic into a query token according to a tokenization configuration;
the transmitting the first query information to the sensing device includes:
transmitting the query token to the sensing device.

The query content transmitted to the sensing device can be in a form of a query token, which enriches the form of the first query information, in addition, the form of token may provide more accurate true intentions and save signaling overhead. Further, the tokenization can be used to prevent a sensing device from recovering a complete query message from a query token. The tokenization may come up with certain privacy protection for query messages.

In a possible implementation of the second aspect, the method further includes:
determining a semantic length and a semantic format;
the translating the query message into the query semantic according to the semantization configuration includes:
translating the query message into a query semantic with the semantic length and the semantic format according to the semantization configuration.

There may be different semantic lengths and different semantic formats for different query messages, an appropriate semantic length and an appropriate semantic format are determined for the specific query message, then the specific query message is translated into the query semantic with the semantic length and the semantic format according to the semantization configuration, thereby ensuring high efficiency of data processing.

In a possible implementation of the second aspect, the method further includes:
obtaining an identifier of the semantization configuration;
the translating the query message into the query semantic according to the semantization configuration includes:
translating the query message into the query semantic according to the semantization configuration with the obtained identifier.

There may be different semantization configurations for different query messages, an identifier of an appropriate semantization configuration is obtained for the specific query message, then the specific query message is translated into the query semantic according to the semantization configuration with the obtained identifier, thereby ensuring high efficiency of data processing.

In a possible implementation of the second aspect, the obtaining the identifier of the semantization configuration includes:
obtaining a predefined identifier of the semantization configuration, or
receiving an identifier of the semantization configuration from the GPT device.

The identifier of the semantization configuration may be predefined, or may be transmitted to the central device from the GPT device, which provides more flexibility and can thus meet different requirements.

In a possible implementation of the second aspect, both the first query information and the second query information include a query semantic.

In the case that both the first query information and the second query information are in a form of a query semantic, it may be unnecessary for the central device to perform any operation on the first query information and/or the second query information, which may save resources for the central device.

In a possible implementation of the second aspect, the second query information includes a query semantic; the method further includes:
tokenizing the query semantic into a query token according to a tokenization configuration;
the transmitting the first query information to the sensing device includes:
transmitting the query token to the sensing device.

In the case that the second query information is in a form of a query semantic, the central device may perform an operation to obtain the query token, the form of token may provide more accurate true intentions and save signaling overhead.

In a possible implementation of the second aspect, the method further includes:
determining a token length according to a size range of the query semantic;
the tokenizing the query semantic into the query token according to the tokenization configuration includes:
tokenizing the query semantic into a query token with the determined token length according to the tokenization configuration.

The token length of the query token is related to the size of the query semantic, which provides a convenient and fast tokenization, thereby ensuring high efficiency of data processing.

In a possible implementation of the second aspect, the method further includes:
obtaining an identifier of the tokenization configuration;
the tokenizing the query semantic into the query token according to the tokenization configuration includes:
tokenizing the query semantic into the query token according to the tokenization configuration with the obtained identifier.

There may be different tokenization configurations for different kinds of query semantic, an identifier of an appropriate tokenization configuration is obtained for the specific kind of query semantic, then the specific kind of query semantic is processed into the query token according to the tokenization configuration with the obtained identifier, thereby ensuring high efficiency of data processing.

In a possible implementation of the second aspect, the obtaining the identifier of the tokenization configuration includes:
obtaining a predefined identifier of the tokenization configuration, or
receiving an identifier of the tokenization configuration from the GPT device.

The identifier of the tokenization configuration may be predefined, or may be transmitted to the central device from the GPT device, which provides more flexibility and can thus meet different requirements.

In a possible implementation of the second aspect, the tokenization configuration includes one of:
a tokenization model;
a tokenization function;
a projection matrix;
a graph-based or topology-based pruning; or
a compression approach.

There are a plurality of tokenization configurations to be chosen, which provides more flexibility and can thus meet different requirements.

In a possible implementation of the second aspect, the query semantic includes a query vector, a query matrix or a query tensor of scalars.

There are different forms of query semantic to be chosen, which provides more flexibility and can thus meet different requirements.

In a possible implementation of the second aspect, both the first query information and the second query information include a query token.

In the case that the first query information and the second query information are in a form of a query token, it may be unnecessary for the central device to perform any operation on the first query information and/or the second query information, which may save resources for the central device.

In a possible implementation of the second aspect, the method further includes:
transmitting at least one of a scoring function for determining a first matching score between the sensed data and the first query information, a first threshold, a function for determining a first distance between the sensed data and the first query information, or a second threshold, to the sensing device.

In a possible implementation of the second aspect, the transmitting the first query information to the sensing device includes:
transmitting the first query information along with at least one of a scoring function for determining a first matching score between the sensed data and the first query information, a first threshold, a function for determining a first distance between the sensed data and the first query information, or a second threshold, to the sensing device.

In a possible implementation of the second aspect, the scoring function includes an inner product or a euclidean distance; and the function for determining the first distance includes an inner product, a cross-correlation matrix, or a cross-entropy function.

The scoring function may be in a form of an inner product, or a euclidean distance; the function for determining the first distance may be in a form of an inner product, a cross-correlation matrix, or a cross-entropy function, that is, the function can be implemented through various methods, which provides more flexibility and can thus meet different requirements.

In a possible implementation of the second aspect, the sensing result includes one of the following:
raw sensed data;
a sensing semantic obtained from raw sensed data;
half raw sensed data and a sensing semantic obtained from raw sensed data;
raw sensed data and a first matching score between the sensed data and the first query information;
raw sensed data and a first distance between the sensed data and the first query information;
a sensing semantic obtained from raw sensed data and a first matching score between the sensed data and the first query information;
a sensing semantic obtained from raw sensed data and a first distance between the sensed data and the first query information;
half raw sensed data, a sensing semantic obtained from raw sensed data, and a first matching score between the sensed data and the first query information;
half raw sensed data, a sensing semantic obtained from raw sensed data, and a first distance between the sensed data and the first query information.

The sensing result may be in various forms related to the sensed data, which provides more flexibility and can thus meet different requirements.

In a possible implementation of the second aspect, the receiving the sensing result from the sensing device includes:
receiving at least two sensing results from at least two sensing devices among the plurality of sensing devices;
the method further includes:
obtaining a fused sensing result by fusing part or all of the at least two sensing results from the at least two sensing devices;
the outputting the sensing result to the GPT device includes:
outputting the fused sensing result to the GPT device.

In the case that there are a plurality of sensing results, the central device may perform a fusing operation on the sensing results, and output the fused sensing result to the GPT device, thus, the fused sensing result is comprehensive, thereby improving the accuracy of the fused sensing result.

In a possible implementation of the second aspect, the at least two sensing results includes at least two matching scores or at least two distances; where the obtaining the fused sensing result by fusing part or all of the at least two sensing results from the at least two sensing devices includes:
obtaining the fused sensing result by fusing, according to the at least two matching scores or the at least two distances, part or all of the at least two sensing results from the at least two sensing devices.

During the fusing operation on the sensing results, by considering the matching score or the distance of each sensing result which may indicate the relevance between the sensing result and the first query information, the at least two sensing results are fused according to the at least two matching scores or the at least two distances, for example, in which the sensing result with the higher matching score or with the smaller distance would be given higher importance in the fusion, thus the impact of some sensing results with lower reliability may be reduced, the accuracy of the fused sensing result is thus further improved, and the reliability of the fused sensing result is ensured.

In a possible implementation of the second aspect, the method further includes:
determining a second matching score between the fused sensing result and the first query information; or
determining a second distance between the fused sensing result and the first query information.

The second matching score or the second distance may indicate the relevance between the fused sensing result and the first query information, that is, the second matching score or the second distance may be used for evaluating the reliability of the fused sensing result.

In a possible implementation of the second aspect, the scoring function includes an inner product; the method further includes:
dividing the first query information into a plurality of sub-blocks;
the transmitting the first query information to the sensing device includes:
transmitting a first sub-block among the plurality of sub-blocks to the sensing device;
the method further includes:
stopping a transmission of a second sub-block among the plurality of sub-blocks other than the first sub-block when determining a number of a certain sensing device among the plurality of sensing devices is greater than or equal to a third threshold, where the second matching score for the certain sensing device is greater than or equal to a fourth threshold or the second distance for the certain sensing device is less than or equal to a fifth threshold; and
continuing the transmission of the second sub-block when determining the number is less than the third threshold.

The number of the certain sensing device whose second matching score is greater than or equal to a fourth threshold or whose second distance is less than or equal to a fifth threshold, is greater than or equal to a third threshold, which ensures the reliability of the fused sensing result. By dividing the first query information into a plurality of sub-blocks, and transmitting a sub-block each time, in the case that the reliability of the fused sensing result is ensured, the transmission of the sub-block is stopped, that is, if there are sufficient number of the sensing devices who feedback their sensing result and the fused sensing result reaches a certain level of relevance (or reliability), the central device may not continue to transmit the second sub-block, the amount of data transmission is thus reduced.

In a possible implementation of the second aspect, the first query information is carried in higher layer signaling or physical layer signaling or a combination of higher layer signaling and physical signaling, where the higher layer signaling includes one of radio resource control (RRC) signaling, medium access control (MAC) layer signaling, and the physical layer signaling includes downlink control information (DCI).

The first query information can be transmitted to the sensing device from the central device through specific signaling, which ensures high security and efficiency of data transmission.

In a possible implementation of the second aspect, the sensing result received from the sensing device is carried in higher layer signaling or physical layer signaling or a combination of higher layer signaling and physical signaling, where the higher layer signaling includes one of radio resource control (RRC) signaling, medium access control (MAC) layer signaling, and the physical layer signaling includes uplink control information (UCI).

In a possible implementation of the second aspect, the receiving the sensing result from the sensing device includes: receiving the sensing result from the sensing device in a physical uplink shared channel or a dedicated uplink channel.

In a third aspect, a communication apparatus is provided in the present disclosure, the apparatus includes various modules configured to execute the communication method according to the first aspect or any possible implementation of the first aspect.

In a fourth aspect, a communication apparatus is provided in the present disclosure, the apparatus includes various modules configured to execute the communication method according to the second aspect or any possible implementation of the second aspect.

In a fifth aspect, a sensing device is provided in the present disclosure, the sensing device includes processing circuitry for executing the communication method according to the first aspect or any possible implementation of the first aspect.

In a sixth aspect, a central device is provided in the present disclosure, the central device includes processing circuitry for executing the communication method according to the second aspect or any possible implementation of the second aspect.

In a seventh aspect, a communication system is provided in the present disclosure, the communication system includes a sensing device according to the fifth aspect and a central device according to the sixth aspect.

In an eighth aspect, a chip is provided in the present disclosure, the chip includes an input/output (I/O) interface and a processor, where the processor is configured to call and run computer execution instructions stored in a memory, to enable a device installing with the chip to execute the communication method according to the first or second aspect or any possible implementation of the first or second aspect.

In a ninth aspect, a computer-readable medium is provided in the present disclosure, the computer-readable medium stores computer execution instructions which, when executed by a processor, causes the processor to execute the communication method according to the first or second aspect or any possible implementation of the first or second aspect.

In a tenth aspect, a computer program product is provided in the present disclosure, the computer program product includes computer execution instructions which, when executed by a processor, causes the processor to execute the communication method according to the first or second aspect or any possible implementation of the first or second aspect.

The present disclosure provides a communication method and related products. The transmission of the sensing result which indicates the sensed data is triggered in the case that the sensed data of the sensing device and the first query information are matched, that is, the transmission of the sensing result for the sensing device has a specific condition, and the sensing result is not transmitted all the time, thus the transmission resources are saved; in addition, the transmitted sensing result meets the requirement of the first query information, that is, irrelevant information is filtered, the transmitted data is what the central device requires, accuracy of data transmission is thus ensured.

### BRIEF DESCRIPTION OF DRAWINGS

The accompanying drawings are used to provide a further understanding of the present disclosure, constitute a part of the specification, and are used to explain the present disclosure together with the following specific example embodiments, but should not be construed as limiting the present disclosure.

FIG. 1 is a schematic illustration of a communication system according to one or more examples of the present disclosure.

FIG. 2 is another schematic illustration of a communication system according to one or more examples of the present disclosure.

FIG. 3 is a schematic illustration of basic component structure of a communication system according to one or more examples of the present disclosure.

FIG. 4 illustrates a block diagram of a device in a communication system according to one or more examples of the present disclosure.

FIG. 5 is a schematic flowchart of a communication method according to one or more examples of the present disclosure.

FIG. 6 is a schematic flowchart of another communication method according to one or more examples of the present disclosure.

FIG. 7 is a schematic flowchart of still another communication method according to one or more examples of the present disclosure.

FIG. 8 is still another schematic illustration of a communication system according to one or more examples of the present disclosure.

FIG. 9 is a schematic illustration of division for sensing devices according to one or more examples of the present disclosure.

FIG. 10 is a schematic illustration of interaction between devices in a communication system according to one or more examples of the present disclosure.

FIG. 11 is another schematic illustration of interaction between devices in a communication system according to one or more examples of the present disclosure.

FIG. 12 is a schematic illustration of generating a sequence of query messages in a communication system according to one or more examples of the present disclosure.

FIG. 13 is a schematic illustration of interaction between a central device and two sensing devices in a communication system according to one or more examples of the present disclosure.

FIG. 14 is another schematic illustration of interaction between a central device and two sensing devices in a communication system according to one or more examples of the present disclosure.

FIG. 15 is a schematic illustration of generating a query semantic by a GPT device in a communication system according to one or more examples of the present disclosure.

FIG. 16 is a schematic illustration of recovering a query message from a query semantic in a communication system according to one or more examples of the present disclosure.

FIG. 17 is a schematic illustration of generating a query token by a GPT device in a communication system according to one or more examples of the present disclosure.

FIG. 18 is a schematic illustration of responding to a query token from a central device by a sensing device according to one or more examples of the present disclosure.

FIG. 19 is a schematic illustration of a scoring operation implemented by a sensing device according to one or more examples of the present disclosure.

FIG. 20 is a schematic illustration of responding to a query semantic from a central device by a sensing device according to one or more examples of the present disclosure.

FIG. 21 is another schematic illustration of a scoring operation implemented by a sensing device according to one or more examples of the present disclosure.

FIG. 22 is another schematic illustration of responding to a query semantic from a central device by a sensing device according to one or more examples of the present disclosure.

FIG. 23 is still another schematic illustration of a scoring operation implemented by a sensing device according to one or more examples of the present disclosure.

FIG. 24 is a schematic illustration of a sensing result according to one or more examples of the present disclosure.

FIG. 25 is a schematic illustration of a fusion operation according to one or more examples of the present disclosure.

FIG. 26 is another schematic illustration of a fusion operation according to one or more examples of the present disclosure.

FIG. 27 is a schematic illustration of generating query semantics by two GPT devices according to one or more examples of the present disclosure.

FIG. 28 is a schematic illustration of generating query tokens by two GPT devices according to one or more examples of the present disclosure.

FIG. 29 is a schematic illustration of handling two query tokens with a common semantization model and two tokenization models by a sensing device according to one or more examples of the present disclosure.

FIG. 30 is a schematic illustration of handling two query tokens with a common semantization model and a common tokenization model by a sensing device according to one or more examples of the present disclosure.

FIG. 31 is a schematic illustration of handling two query tokens with two semantization models and two tokenization models by a sensing device according to one or more examples of the present disclosure.

FIG. 32 is a schematic illustration of handling two query tokens with two semantization models and a common tokenization model by a sensing device according to one or more examples of the present disclosure.

FIG. 33 is a schematic illustration of handling two query semantics with a common semantization model and two tokenization models by a sensing device according to one or more examples of the present disclosure.

FIG. 34 is a schematic illustration of handling two query semantics with a common semantization model and a common tokenization model by a sensing device according to one or more examples of the present disclosure.

FIG. 35 is a schematic illustration of handling two query semantics with two semantizations model and two tokenization models by a sensing device according to one or more examples of the present disclosure.

FIG. 36 is a schematic illustration of handling two query semantics with two semantizations model and one tokenization model by a sensing device according to one or more examples of the present disclosure.

FIG. 37 is a schematic illustration of handling two query semantics with one semantization model and without tokenization model by a sensing device according to one or more examples of the present disclosure.

FIG. 38 is a schematic illustration of handling two query semantics with two semantization models and without tokenization model by a sensing device according to one or more examples of the present disclosure.

FIG. 39 is a schematic illustration of processing two sensing semantics independently according to one or more examples of the present disclosure.

FIG. 40 is a schematic illustration of processing one sensing semantic but with two tasks according to one or more examples of the present disclosure.

FIG. 41 is a block diagram of a communication apparatus according to one or more examples of the present disclosure.

FIG. 42 is a block diagram of another communication apparatus according to one or more examples of the present disclosure.

### DESCRIPTION OF EMBODIMENTS

In the following description, reference is made to the accompanying figures, which form part of the present disclosure, and which show, by way of illustration, specific aspects of examples of the present disclosure or specific aspects in which examples of the present disclosure may be used. It is understood that examples of the present disclosure may be used in other aspects and include structural or logical changes not depicted in the figures. The following detailed description, therefore, is not to be taken in a limiting sense, and the scope of the present disclosure is defined by the appended claims.

To assist in understanding the present disclosure, examples of wireless communication systems and devices are described below.

### Example Communication Systems and Devices

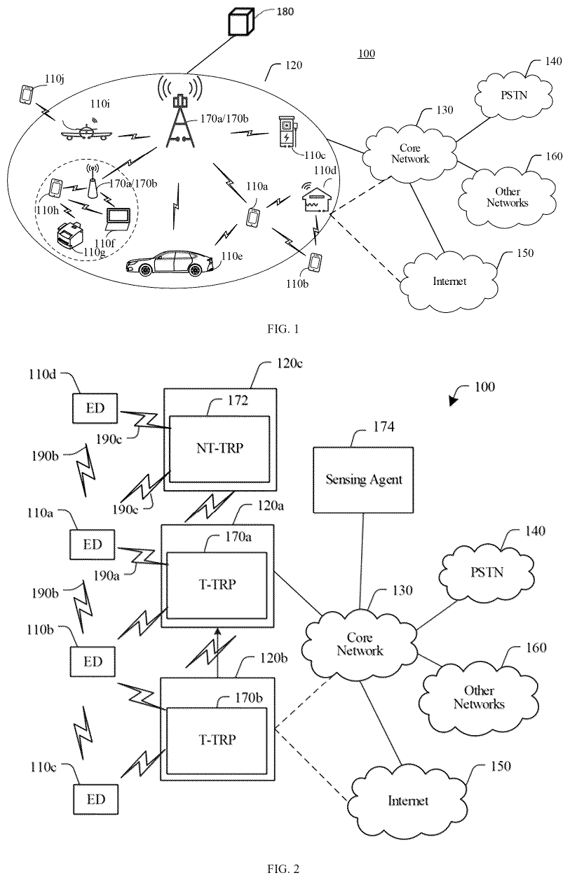

The present disclosure uses the interaction and processing procedures among at least one UE (i.e., the sensing device which is also called a sensing node, which is marked as ED in FIG. 1), at least one BS (i.e., the central device) and at least one GPT device in a wireless system as an illustrative example. The exchanged information and protocol flows can also be used between other network nodes described below, for example, between ED 110 and TRP 170, between ED 110 and core network, between ED 110 and ED 110, between TRP 170 and TRP 170, between TRP 170 and GPT device 180. The UE in the procedure described in the present disclosure may be replaced with a sensing node mentioned below. The BS in the procedure described in the present disclosure may be replaced with a sensing coordinator. The sensing coordinator are nodes in a network that can assist in the sensing operation. These nodes can be stand-alone nodes dedicated to just sensing operations or other nodes (for example TRP 170, ED 110, or core network node shown below) doing the sensing operations in parallel with communication transmissions.

Referring to FIG. 1, as an illustrative example without limitation, a simplified schematic illustration of a communication system is provided. The communication system 100 (which may be the wireless system in FIG. 1) comprises a radio access network 120. The radio access network 120 may be a next generation (e.g., sixth generation (6G) or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

The uplink messages/data transmitted between the central device (e.g., the network node 170) and the sensing device (e.g., ED 180) could be carried in higher layer signaling, such as RRC signaling, or MAC layer signaling. Or, they could be carried in physical layer signaling, e.g., UCI. Or they could be carried in the combination of the higher layer signaling and the physical signaling. It could be noted that the message in the present disclosure could be replaced with information, which may be carried in one single message, or be carried in more than one separate message. The downlink messages/data transmitted between the central device and the ED 110 could be carried in higher layer signaling, such as RRC signaling, or MAC layer signaling. Or, they could be carried in physical layer signaling, e.g., DCI. Or they could be carried in the combination of the higher layer signaling and the physical signaling. It could be noted that the message in the present disclosure could be replaced with information, which may be carried in one single message, or be carried in more than one separate message.

In addition, the communication system 100 comprises at least one GPT device 180. The GPT device 180 may be located within the one or more network node 170. The GPT device 180 may be an independent device connected to the network 170, such as an ED 110 which connected to the network node 170 via Uu interface. The GPT device 180 may be a device connected to the network node 170 vial core network 130. When the GPT device 180 is an ED, the uplink messages/data transmitted between the central device (e.g., the network node 170) and the GPT device 180 could be carried in higher layer signaling, such as RRC signaling, or MAC layer signaling. Or, they could be carried in physical layer signaling, e.g., UCI. Or they could be carried in the combination of the higher layer signaling and the physical signaling. It could be noted that the message in the present disclosure could be replaced with information, which may be carried in one single message, or be carried in more than one separate message. The downlink messages/data transmitted between the central device and the GPT device 180 could be carried in higher layer signaling, such as RRC signaling, or MAC layer signaling. Or, they could be carried in physical layer signaling, e.g., DCI. Or they could be carried in the combination of the higher layer signaling and the physical signaling. It could be noted that the message in the present disclosure could be replaced with information, which may be carried in one single message, or be carried in more than one separate message.

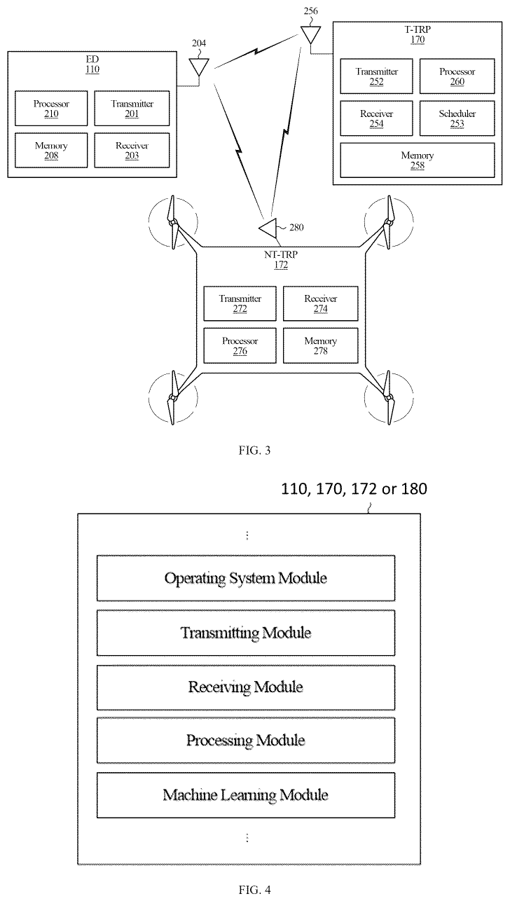

FIG. 2 illustrates an example communication system 100. In general, the communication system 100 enables multiple wireless or wired elements to communicate data and other content. The purpose of the communication system 100 may be to provide content, such as voice, data, video, signaling and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a-120b, a non-terrestrial communication network 120c, a core network 130, a public switched telephone network (PSTN) 140, the Internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a-170b and NT-TRP 172, the Internet 150, the core network 130, the PSTN 140, the other networks 160, or any combination of the preceding. In some examples, ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), Direct Fourier Transform spread OFDMA (DFT-OFDMA) or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

### Basic Component Structure

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices such as a watch, head mounted equipment, a pair of glasses, an industrial device, or apparatus (e.g., communication module, modem, or chip) in the foregoing devices, among other possibilities. Future generation EDs 110 may be referred to using other terms. Each base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas 204 may alternatively be panels. The transmitter 201 and the receiver 203 may be integrated, e.g., as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to or receiving information from a user, such as through operation as a speaker, a microphone, a keypad, a keyboard, a display, or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., in the memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), a Central Processing Unit (CPU) or an application-specific integrated circuit (ASIC).

In some implementations, the ED 110 may be an apparatus (also called component) for example, communication module, modem, chip, or chipset, it includes at least one processor 210, and an interface or at least one pin. In this scenario, the transmitter 201 and receiver 203 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or another ED 110 may be referred as transmitting information to the interface or at least one pin, or as transmitting information to the NT-TRP 172 and/or the T-TRP 170 and/or another ED 110 via the interface or at least one pin, and receiving information from the NT-TRP 172 and/or the T-TRP 170 and/or another ED 110 may be referred as receiving information from the interface or at least one pin, or as receiving information from the NT-TRP 172 and/or the T-TRP 170 and/or another ED 110 via the interface or at least one pin. The information may include control signaling and/or data.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the foregoing devices or refer to apparatus (e.g., a communication module, a modem, or a chip) in the foregoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to the NT-TRP 172, and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming, and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH), and static or semi-static higher layer signaling may be included in a packet transmitted in a data channel, e.g., in a physical downlink shared channel (PDSCH).

The scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same or different one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU, a CPU, or an ASIC.

When the T-TRP 170 is an apparatus (also called as component), for example, communication module, modem, chip, or chipset in a device, it includes at least one processor, and an interface or at least one pin. In this scenario, the transmitter 252 and receiver 254 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or ED 110 may be referred as transmitting information to the interface or at least one pin, and receiving information from the NT-TRP 172 and/or the T-TRP 170 and/or ED 110 may be referred as receiving information from the interface or at least one pin. The information may include control signaling and/or data.

Although the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g., MIMO precoding), transmit beamforming, and generating symbols for transmission. Processing operations related to processing received transmissions in the uplink or over backhaul may include operations such as receive beamforming, demodulating received symbols and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU, a CPU, or an ASIC. In some embodiments, the NT-TRP 172 may actually be a plurality of NT-TRPs that are operating together to serve the ED 110, e.g., through coordinated multipoint transmissions.

When the NT-TRP 172 is an apparatus (e.g., communication module, modem, chip, or chipset) in a device, it includes at least one processor, and an interface or at least one pin. In this scenario, the transmitter 272 and receiver 257 may be replaced by the interface or at least one pin, wherein the interface or at least one pin is to connect the apparatus (e.g., chip) and other apparatus (e.g., chip, memory, or bus). Accordingly, the transmitting information to the T-TRP 170 and/or another NT-TRP 172 and/or ED 110 may be referred as transmitting information to the interface or at least one pin, and receiving information from the T-TRP 170 and/or another NT-TRP 172 and/or ED 110 may be referred as receiving information from the interface or at least one pin. The information may include control signaling and/or data.

Note that “TRP,” as used herein, may refer to a T-TRP or a NT-TRP. A T-TRP may alternatively be called a terrestrial network TRP (“TN TRP”) and a NT-TRP may alternatively be called a non-terrestrial network TRP (“NTN TRP”).

The T-TRP 170, the NT-TRP 172, and/or the ED 110 may include other components, but these have been omitted for the sake of clarity.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications, and are instead dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

Although not presented in FIG. 3, a GPT device 180 may be included, which has similar structure to ED 110, e.g., GPT device 180 includes at least one processor, a transmitting and a receiver.

### Basic Module Structure

One or more steps of the methods provided herein may be performed by corresponding units or modules, according to FIG. 4. FIG. 4 illustrates units or modules in a device, such as in the ED 110, in the T-TRP 170, in the NT-TRP 172, or in the GPT device 180. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, a CPU, or an ASIC. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation. The transmitter mentioned with reference to FIG. 3 may be a detailed implementation for the transmitting module. The receiver mentioned with reference to FIG. 3 may be a detailed implementation for the receiving module. The processor mentioned with reference to FIG. 3 may be a detailed implementation for the processing module.

Additional details regarding the EDs 110, the T-TRP 170, the NT-TRP 172 and the GPT device 180 are known to those of skill in the art. As such, these details are omitted here.

### Example Concepts of Some Terms

Message: a payload in a natural language, e.g., English, French, Chinese, etc.

Query message: a query sentence in a natural language.

Sensing message: a description about an observation or sensed data in a natural language.

Semantic: a vector, a matrix, a tensor of scalars to embed a message.

Query semantic: a semantic that embeds a query message.

Sensing semantic: a semantic that embeds a sensing message.

Token: a vector of scalars encoded from a semantic.

Query token: a token that is encoded from a query semantic.

Sensing token: a token that is encoded from a sensing semantic.

GPT device: a device that runs over generative AI model or models to generate a query message or messages given a sensing message or messages.

Central device: a device as BS that connects a plurality of terminal devices via radio access in DL and UL, and connects with the core network via backbone network.

Sensing device: a device as terminal that connects to a BS or BSs and that is equipped with the sensing gadget to measure data of interest near it.

The above describes possible scenarios or generalized description of the examples of the present disclosure, the motivation and technical concepts of the present disclosure are illustrated in the following.

A sensing function will be integrated into the 6th generation (6G) system. A large number of the sensing user equipments (UEs) or sensing devices will be densely deployed in cities, factories, farms and so on. In addition to mobile phones, sensing devices will become an important type of UEs or devices that claim an arrival of IoT time.

Like internet searching engines, 6G will come up with the counterpart, an internet of thing (IoT) searching engine, in a true physical world. In fact, billions of IoT-based applications such as driverless cars, automation factories, smart cities, autonomous farms, will heavily depend on an efficient and real-time searching engine in our physical world.

Recently, artificial intelligence (AI) has conquered various intellectual and cognitive domains. some AI is exploring the cutting edge of our intellectual knowledge in chemistry, gaming, mathematics, gene engineering; some other AI is providing a human-level Q&A platform in the digital world; the domain that AI has not conquered is the real-time physical world. Physical-world AI, in which AI technologies are to penetrate into all the aspects of our society and life, may be built on omnipresent IoT connections thanks to 6G.

More challenging than internet searching engine, a real-world searching engine would have to search the physical world in real time over a large scale of physical area and to deal with a multitude of types of data and information (some may be novel and some may not have been invented yet). Furthermore, green technology, low-energy and low-emission, is also raised as key features of 6G. A sensing device may be battery powered and/or completely powered by solar and wind. It would be costly and impracticable to ask all the sensing devices in a large scale to feedback what they are sensing at the same time. On one hand, the frequent sensing and transmission consumes a sensing device much energy and reduce their battery life time; on other hand, such a high density of the IoT deployment may block the uplink channels, especially the uplink (UL) bandwidth is more expensive than the downlink (DL) one.

In some implementations, a sensing device may be a UE, a mobile phone or a handset, where independence among any two sensing devices are assumed; thereby, a sensing device may be scheduled individually by the wireless system to which the sensing device is associated; and the sensed data that the sensing device measures may be application-level payload for the wireless system and protocol.

The above scheme of scheduling a sensing device is inefficient in terms of radio bandwidth and energy consumption. For instance, a sensing device blindly keeps transmitting its sensed data to the central device, regardless of whether the sensed data is required or not.

From a higher level perspective, it is better to wake a plurality of sensing devices to measure and transmit only when their sensed data would serve a goal or goals; for example, when a generative pre-trained transformer (GPT) device such as a driverless car, may request the information about the moving obstacles near itself, it is useless to keep transmitting irrelevant information to the driverless car, or to transmit all the moving obstacles nearby to the car when the car is parking on the roadside.

To avoid any missing probability of the information, resources in the wireless system in above implementations may be over-scheduled.

The basic concepts of the present disclosure may be as follows. When receiving query information (or referred to as first query information, a query, a query message, or a first query message, etc.), not all the sensing devices feedback what they are sensing, only the sensing devices whose sensed data has sufficient relevance with the query information (i.e., the sensed data and the query information are matched) would response and transmit their sensed data.

The above briefly describes technical concepts of the present disclosure, and then specific examples of the present disclosure will be elaborated in the following description.

The present disclosure provides a communication method, as shown in FIG. 5, the communication method may be implemented by a sensing device, and may include the following steps.

Step 502, a sensing device determines whether sensed data and first query information are matched.

The sensing device is responsible for measuring and/or collecting local physical-world data. It may be sensing UE, sensing equipment, IoT equipment, UE, mobile phones, handset, or other equipment. The sensing device may be equipped with a sensing gadget or component to measure local physical-world data or information which may be referred to as sensed data. Further, the sensing device may encode and transmit the sensed data to a central device. The first query information is used for retrieving related data from the sensing device. Specifically, the first query information may be a question in natural language or in machine-readable language, which is not limited herein. For example, the first query information may be in a form of a query message, a query semantic, a query token, etc. Details about the obtaining and the transmission manner of the first query information will be described later.

The sensed data and the first query information are matched or not can be implemented based on a first matching score between the sensed data and the first query information, or a distance between the sensed data and the first query information, etc. The implementation details will be described later.

Step 504, the sensing device transmits a sensing result to a central device when the sensed data and the first query information are matched, where the sensing result indicates the sensed data.

The central device may be a base station (BS), e.g., gNB, or eNB etc., or the central device may be an access point (AP). The sensing result is related to the sensed data obtained by the sensing device. If the sensed data and the first query information are matched, the sensing device will respond with the sensing result. If the sensed data and the first query information are not matched, the sensing device will not respond. Details about the specific contents and the transmission manner of the sensing result will be described later.

The transmission of the sensing result which indicates the sensed data is triggered in the case that the sensed data and the first query information are matched, that is, the transmission of the sensing result has a specific condition, and the sensing result is not transmitted all the time, thus the transmission resources are saved; in addition, the transmitted sensing result meets the requirement of the first query information, that is, irrelevant information is filtered, the transmitted data is what the central device requires, responding accuracy is thus ensured.

In a possible implementation, the sensing device receives the first query information from the central device. The first query information from the central device wakes a sensing device to measure and transmit the sensing result when the sensed data and the first query information are matched, that is, the sensing device starts the computation of the matching determination in response to the first query information, and may not start the computation of the matching determination under other circumstances, the energy consumption for the sensing device is thus reduced.

It should be noted that in some circumstances, some sensing devices may actively transmit their sensing result without receiving any query information from the central device. The sensing devices that actively transmit the sensing result may respond to some urgency queries such as fire alarming or car accidents. In some sense, some query messages have been pre-defined and configured into the system by default.

Specifically, the sensing device may receive the first query information broadcasted or multicasted by the central device. The received first query information is broadcasted or multicasted by the central device, thus, the first query information can be transmitted to a plurality of sensing devices, the transmission efficiency of the first query information is thus improved.

The first query information may be in various forms, since the comparing objects should be in the same form, a comparison between the first query information and the sensed data may have various implementations, which will be described in the following. It should be noted that, the following implementations are only illustrative, and there may be other implementations, which is not limited herein.

In a possible implementation, the first query information includes a query message, the sensing device obtains the sensed data, and determines whether the sensed data and the query message are matched. The sensed data is in a form of natural language, in the case that the first query information is in a form of a query message, i.e., also in a form of natural language, since the comparing objects are in the same form, the sensed data and the query message can be directly compared to determine whether the sensed data and the query message are matched or not. A simple and convenient manner to obtain a comparing result is thus provided.

In a possible implementation, the first query information includes a query message, the sensing device obtains the sensed data, translates the sensed data into a sensing semantic according to a semantization configuration, and translates the query message into a query semantic according to the semantization configuration, then determines whether the sensing semantic and the query semantic are matched. In the case that both the sensed data and the first query information are in a form of natural language, they can be translated into the sensing semantic and the query semantic respectively, the translation of the sensed data and the query message are implemented according to the same semantization configuration, thus, the sensing semantic and the query semantic are in the same form, then the comparison is implemented between the sensing semantic and the query semantic. That is, both the sensed data and the query message are translated into a common semantic domain on which they can be easily compared to each other and fused. Since the form of semantic may provide more accurate true intentions, accuracy of a comparing result is thus improved. It should be noted that a translating operation in the present disclosure refers to the semantization processing, and the translating operation can be replaced with an embedding operation, a converting operation, a transforming operation, etc. For example, the translating the sensed data into the sensing semantic can be replaced with embedding the sensed data into the sensing semantic, converting the sensed data into the sensing semantic, transforming the sensed data into the sensing semantic, etc. The specific means of the translating operation, the embedding operation, the converting operation, the transforming operation are not limited here. For example, the transforming operation can be implemented by using an existing manner.

In a possible implementation, the first query information includes a query semantic; the sensing device obtains the sensed data, translates the sensed data into a sensing semantic according to a semantization configuration, then determines whether the sensing semantic and the query semantic are matched. In the case that the sensed data is in a form of natural language, while the first query information is in a form of semantic, the sensed data can be translated into the sensing semantic, then the comparison is implemented between the sensing semantic and the query semantic. That is, both the sensed data and the query information are in a common semantic domain on which they can be easily compared to each other and fused. A query semantic may preserve all the key semantic goals conveyed by the query message such that the query semantic can be well translated (de-semantized) back to a query message. Since the form of semantic may provide more accurate true intentions, accuracy of a comparing result is thus improved.

In a possible implementation, the first query information includes a query message; the sensing device obtains the sensed data, translates the sensed data into a sensing semantic according to a semantization configuration, tokenizes the sensing semantic into a sensing token according to a tokenization configuration, and translates the query message into a query semantic according to the semantization configuration, tokenizes the query semantic into a query token according to the tokenization configuration, then determines whether the sensing token and the query token are matched. In the case that both the sensed data and the first query information are in a form of natural language, they can be processed into the sensing token and the query token respectively, the translation of the sensed data and the query message are implemented according to the same semantization configuration and the same tokenization configuration, thus, the sensing token and the query token are in the same form, then the comparison is implemented between the sensing token and the query token. Since the form of token may provide more accurate true intentions and save signaling overhead, accuracy of a comparing result is thus improved and signaling overhead is saved. Further, the tokenization can be used to prevent a sensing device from recovering a complete query message from a query token. The tokenization may come up with certain privacy protection for query messages.

In a possible implementation, the first query information includes a query semantic; the sensing device obtains the sensed data, translates the sensed data into a sensing semantic according to a semantization configuration, tokenizes the sensing semantic into a sensing token according to a tokenization configuration, and tokenizes the query semantic into a query token according to the tokenization configuration, then determines whether the sensing token and the query token are matched. In the case that the sensed data is in a form of natural language, while the first query information is in a form of semantic, the sensed data can be processed into the sensing token, and the query semantic can be processed into the query token, then the comparison is implemented between the sensing token and the query token. Since the form of token may provide more accurate true intentions and save signaling overhead, accuracy of a comparing result is thus improved and signaling overhead is saved. Further, the tokenization can be used to prevent a sensing device from recovering a complete query message from a query token. The tokenization may come up with certain privacy protection for query messages.

In a possible implementation, the first query information includes a query token; the sensing device obtains the sensed data, translates the sensed data into a sensing semantic according to a semantization configuration, tokenizes the sensing semantic into a sensing token according to a tokenization configuration, then determines whether the sensing token and the query token are matched. In the case that the sensed data is in a form of natural language, while the first query information is in a form of token, the sensed data can be processed into the sensing token, then the comparison is implemented between the sensing token and the query token. Since the form of token may provide more accurate true intentions and save signaling overhead, accuracy of a comparing result is thus improved and signaling overhead is saved. Further, the tokenization can be used to prevent a sensing device from recovering a complete query message from a query token. The tokenization may come up with certain privacy protection for query messages.

In a possible implementation, the sensing device determines a semantic length and a semantic format, and translates the sensed data into the sensing semantic with the semantic length and the semantic format according to the semantization configuration. There may be different semantic lengths and different semantic formats for different kinds of sensed data, an appropriate semantic length and an appropriate semantic format are determined for the specific kind of sensed data, then the specific kind of sensed data is translated into the sensing semantic with the semantic length and the semantic format according to the semantization configuration, thereby ensuring high efficiency of data processing.

In a possible implementation, the sensing device obtains an identifier of the semantization configuration, and translates the sensed data into the sensing semantic according to the semantization configuration with the obtained identifier. There may be different semantization configurations for different kinds of sensed data, an identifier of an appropriate semantization configuration is obtained for the specific kind of sensed data, then the specific kind of sensed data is translated into the sensing semantic according to the semantization configuration with the obtained identifier, thereby ensuring high efficiency of data processing. Specifically, the sensing device obtains a predefined identifier of the semantization configuration, or receives an identifier of the semantization configuration from the central device. The identifier of the semantization configuration may be predefined, or may be transmitted to the sensing device from the central device, which provides more flexibility and can thus meet different requirements.

In a possible implementation, the sensing device determines a token length according to a length of the query token, and tokenizes the sensing semantic into a sensing token with the token length according to the tokenization configuration. The token length of the sensing token is related to the length of the query token, which provides a convenient and fast comparison between the sensing token and the query token, thereby ensuring high efficiency of data processing.

In a possible implementation, the sensing device obtains an identifier of the tokenization configuration, and tokenizes the sensing semantic into the sensing token according to the tokenization configuration with the obtained identifier. There may be different tokenization configurations for different kinds of sensing semantic, an identifier of an appropriate tokenization configuration is obtained for the specific kind of sensing semantic, then the specific kind of sensing semantic is processed into the sensing token according to the tokenization configuration with the obtained identifier, thereby ensuring high efficiency of data processing. Specifically, the sensing device obtains a predefined identifier of the tokenization configuration, or receives an identifier of the tokenization configuration from the central device. The identifier of the tokenization configuration may be predefined, or may be transmitted to the sensing device from the central device, which provides more flexibility and can thus meet different requirements.

In a possible implementation, the tokenization configuration includes one of the following: a tokenization model, a tokenization function, a projection matrix, a graph-based or topology-based pruning, a compression approach. There are a plurality of tokenization configurations to be chosen, which provides more flexibility and can thus meet different requirements. The above lists some implementations for the tokenization, the specific means of the tokenization implementations are not limited here. For example, the tokenization model can be implemented by using an existing manner.

In a possible implementation, when receiving the first query information, the sensing device with a sensing function obtains sensed data, and determines whether the sensed data and the first query information are matched. The specific means for determining whether the sensed data and the first query information are matched may be as follows. If a first matching score between the sensed data and the first query information is greater than or equal to a first threshold, it is determined that the sensed data and the first query information are matched; otherwise, it is determined that the sensed data and the first query information are not matched. Or, if a first distance between the sensed data and the first query information is less than or equal to a second threshold, it is determined that the sensed data and the first query information are matched; otherwise, it is determined that the sensed data and the first query information are not matched. The sensed data and the first query information are matched or not can be implemented based on a first matching score between the sensed data and the first query information, or a first distance between the sensed data and the first query information, which provides an efficient implementation. It should be noted that other metrics such as the score of relevance between the sensed data and the first query information or the similarity between the sensed data and the first query information can also be used to indicate whether the sensed data and the first query information are matched or not. The foregoing implementations are only illustrative and not restrictive.

In a possible implementation, the sensing device obtains at least one of a scoring function for determining the first matching score, the first threshold, a function for determining the first distance, or the second threshold. The first matching score between the sensed data and the first query information can be computed through a scoring function, the first distance between the sensed data and the first query information can be computed through a corresponding function, which provides an efficient implementation. In a possible implementation, at least one of the scoring function for determining the first matching score, the first threshold, the function for determining the first distance, the second threshold may be predefined for the sensing device, or may be transmitted by the central device to the sensing device along with the first query information, or may be transmitted to the sensing device before the central device transmits the first query information. The scoring function may be in a form of an inner product or a euclidean distance; and the function for determining the first distance may be in a form of an inner product, a cross-correlation matrix, or a cross-entropy function, the above implementation forms are only illustrative and not restrictive, it should be noted that there may be other methods to implement the above functions. This provides more flexibility and can thus meet different requirements. It should be noted that a threshold in the present disclosure may be predefined or selected according to actual needs.

In a possible implementation, the sensing result includes one of the following: raw sensed data; a sensing semantic obtained from raw sensed data; half raw sensed data and a sensing semantic obtained from raw sensed data; raw sensed data and a first matching score between the sensed data and the first query information; raw sensed data and a first distance between the sensed data and the first query information; a sensing semantic obtained from raw sensed data and a first matching score between the sensed data and the first query information; a sensing semantic obtained from raw sensed data and a first distance between the sensed data and the first query information; half raw sensed data, a sensing semantic obtained from raw sensed data, and a first matching score between the sensed data and the first query information; half raw sensed data, a sensing semantic obtained from raw sensed data, and a first distance between the sensed data and the first query information. The sensing result may be in various forms related to the sensed data, which provides more flexibility and can thus meet different requirements.

In a possible implementation, the first query information may be carried in higher layer signaling or physical layer signaling or a combination of higher layer signaling and physical signaling, where the higher layer signaling includes one of radio resource control (RRC) signaling, medium access control (MAC) layer signaling, and the physical layer signaling includes downlink control information (DCI). The first query information can be transmitted to the sensing device from the central device through specific signaling, which ensures high security and efficiency of data transmission.

In a possible implementation, the sensing device may transmit the sensing result to the central device in a physical uplink shared channel or a dedicated uplink channel. The sensing result can be transmitted to the central device from the sensing device through a specific channel, which ensures high security and efficiency of data transmission. The sensing result transmitted to the central device by the sensing device may be carried in higher layer signaling or physical layer signaling or a combination of higher layer signaling and physical signaling, where the higher layer signaling includes one of radio resource control (RRC) signaling, medium access control (MAC) layer signaling, and the physical layer signaling includes uplink control information (UCI). The sensing result can be transmitted to the central device from the sensing device through specific signaling, which ensures high security and efficiency of data transmission.

In the above, the communication method of the present disclosure is described from the perspective of the sensing device in combination with FIG. 5. In the following, a communication method of the present disclosure will be described from the perspective of a central device, and the method can include the following:
a central device receives a sensing result from a sensing device, where sensed data of the sensing device and first query information for the sensing device are matched, and the sensing result indicates the sensed data.

Regarding the description for the above step, reference may be made to the description for step 502 and step 504, which will not be repeated here. A central device receives the sensing result which indicates the sensed data in the case that the sensed data and the first query information are matched, the received sensing result meets the requirement of the first query information, that is, irrelevant information is filtered, the received data is what the central device requires, accuracy of data transmission is thus ensured.

In a possible implementation, the central device transmits the first query information to the sensing device. Specifically, the central device may broadcast or multicast the first query information to a plurality of sensing devices, the transmission efficiency of the first query information is thus improved. The first query information from the central device is used for waking a sensing device to measure and transmit the sensed dada when the sensed data and the first query information are matched. Specifically, the first query information may be carried in higher layer signaling or physical layer signaling or a combination of higher layer signaling and physical signaling, where the higher layer signaling includes one of radio resource control (RRC) signaling, medium access control (MAC) layer signaling, and the physical layer signaling includes downlink control information (DCI). The first query information can be transmitted to the sensing device from the central device through specific signaling, which ensures high security and efficiency of data transmission.

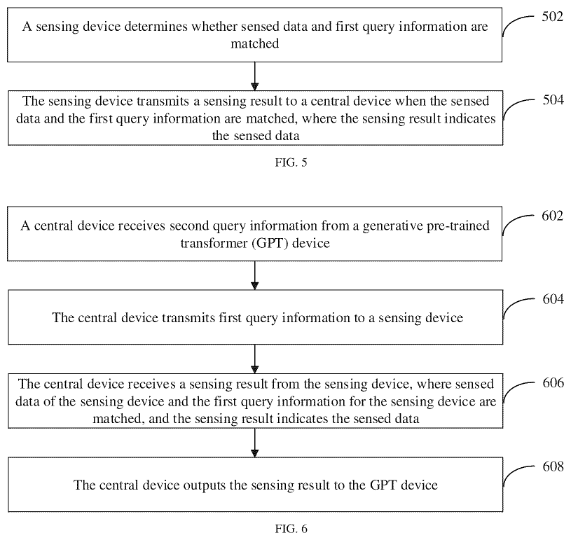

In a possible implementation, as shown in FIG. 6, the communication method includes:
step 602, a central device receives second query information from a generative pre-trained transformer (GPT) device;
step 604, the central device transmits first query information to a sensing device;
step 606, the central device receives a sensing result from the sensing device, where sensed data of the sensing device and the first query information for the sensing device are matched, and the sensing result indicates the sensed data; and
step 608, the central device outputs the sensing result to the GPT device.

Regarding the description for step 604 and step 606, reference may be made to the description for step 502 and step 504, which will not be repeated here. The second query information is used for the central device to generate the first query information. The central device may directly forward query information received from the GPT device to the sensing devices, or, may perform processing (e.g., semantization processing, tokenization processing, etc.) on the received query information from the GPT device, and then transmit the processed query information to the sensing devices. The central device receives the second query information from the GPT device, transmits the first query information to the sensing device, then receives the sensing result from the sensing device, and outputs the sensing result to the GPT device, the central device serves as a bridge between the sensing device and the GPT device, thereby assisting in smooth communication between the sensing device and the GPT device.

The first query information and the second query information may be in the same form, or may be in different forms. Next, some implementations are illustrated, and there may be other implementations, which are not limited herein.

In a possible implementation, both the first query information and the second query information include a query message. In response to the received second query information in a form of a query message from the GPT device, the central device directly transmits the first query information in a form of a query message to the sensing device for subsequent processing, a simple and convenient transmission manner for the first query information is thus provided.

In a possible implementation, the second query information includes a query message, the central device translates the query message into a query semantic according to a semantization configuration, and transmits the query semantic to the sensing device. The query content transmitted to the sensing device can be in a form of a query semantic, which enriches the form of the first query information, in addition, the form of semantic may provide more accurate true intentions. The query semantic may preserve all the key semantic goals conveyed by the query message such that the query semantic can be well translated (de-semantized) back to a query message.

In a possible implementation, the second query information includes a query message, the central device translates the query message into a query semantic according to a semantization configuration, tokenizes the query semantic into a query token according to a tokenization configuration, then transmits the query token to the sensing device. The query content transmitted to the sensing device can be in a form of a query token, which enriches the form of the first query information, in addition, the form of token may provide more accurate true intentions and save signaling overhead. Further, the tokenization can be used to prevent a sensing device from recovering a complete query message from a query token. The tokenization may come up with certain privacy protection for query messages.

In a possible implementation, the central device determines a semantic length and a semantic format, and translates the query message into a query semantic with the semantic length and the semantic format according to the semantization configuration. There may be different semantic lengths and different semantic formats for different query messages, an appropriate semantic length and an appropriate semantic format are determined for the specific query message, then the specific query message is translated into the query semantic with the semantic length and the semantic format according to the semantization configuration, thereby ensuring high efficiency of data processing.

In a possible implementation, the central device obtains an identifier of the semantization configuration, and translates the query message into the query semantic according to the semantization configuration with the obtained identifier. There may be different semantization configurations for different query messages, an identifier of an appropriate semantization configuration is obtained for the specific query message, then the specific query message is translated into the query semantic according to the semantization configuration with the obtained identifier, thereby ensuring high efficiency of data processing.

Specifically, the central device may obtain a predefined identifier of the semantization configuration, or receive an identifier of the semantization configuration from the GPT device. The identifier of the semantization configuration may be predefined, or may be transmitted to the central device from the GPT device, which provides more flexibility and can thus meet different requirements.

In a possible implementation, both the first query information and the second query information include a query semantic. In the case that both the first query information and the second query information are in a form of a query semantic, it may be unnecessary for the central device to perform any operation on the first query information and/or the second query information, which may save resources for the central device.

In a possible implementation, the second query information includes a query semantic, the central device tokenizes the query semantic into a query token according to a tokenization configuration, and transmits the query token to the sensing device. In the case that the second query information is in a form of a query semantic, the central device may perform an operation to obtain the query token, the form of token may provide more accurate true intentions and save signaling overhead.

In a possible implementation, the central device determines a token length according to a size range of the query semantic, and tokenizes the query semantic into a query token with the determined token length according to the tokenization configuration. The token length of the query token is related to the size of the query semantic, which provides a convenient and fast tokenization, thereby ensuring high efficiency of data processing.

In a possible implementation, the central device obtains an identifier of the tokenization configuration, and tokenizes the query semantic into the query token according to the tokenization configuration with the obtained identifier. There may be different tokenization configurations for different kinds of query semantic, an identifier of an appropriate tokenization configuration is obtained for the specific kind of query semantic, then the specific kind of query semantic is processed into the query token according to the tokenization configuration with the obtained identifier, thereby ensuring high efficiency of data processing.

Specifically, the central device may obtain a predefined identifier of the tokenization configuration, or receive an identifier of the tokenization configuration from the GPT device. The identifier of the tokenization configuration may be predefined, or may be transmitted to the central device from the GPT device, which provides more flexibility and can thus meet different requirements.

In a possible implementation, the tokenization configuration includes one of the following: a tokenization model, a tokenization function, a projection matrix, a graph-based or topology-based pruning, a compression approach. There are a plurality of tokenization configurations to be chosen, which provides more flexibility and can thus meet different requirements.

In a possible implementation, the query semantic includes a query vector, a query matrix or a query tensor of scalars. There are different forms of query semantic to be chosen, which provides more flexibility and can thus meet different requirements.

In a possible implementation, both the first query information and the second query information include a query token. In the case that the first query information and the second query information are in a form of a query token, it may be unnecessary for the central device to perform any operation on the first query information and/or the second query information, which may save resources for the central device.

In a possible implementation, the central device transmits at least one of a scoring function for determining a first matching score between the sensed data and the first query information, a first threshold, a function for determining a first distance between the sensed data and the first query information, or a second threshold, to the sensing device. In a possible implementation, the central device may transmit the first query information along with at least one of a scoring function for determining a first matching score between the sensed data and the first query information, a first threshold, a function for determining a first distance between the sensed data and the first query information, or a second threshold, to the sensing device. The scoring function, the first threshold, the function for determining a first distance and the second threshold are used for determining whether the sensed data and the first query information are matched. Reference may be made to the foregoing description from the perspective of the sensing device, which will not repeated here.

In a possible implementation, as shown in FIG. 7, the communication method includes:
step 702, a central device receives second query information from a GPT device;
step 704, the central device transmits first query information to a plurality of sensing devices;
step 706, the central device receives at least two sensing results from at least two sensing devices among the plurality of sensing devices;
step 708, the central device obtains a fused sensing result by fusing part or all of the at least two sensing results from the at least two sensing devices; and
step 710, the central device outputs the fused sensing result to the GPT device.

For example, the central device may transmit the first query information to four sensing devices, and three of the four sensing devices respond with their sensing results. Then, the central device may select two or three sensing results from the three sensing results, fuse the selected sensing results to obtain a fused sensing result, and output the fused sensing result to the GPT device. In the case that there are a plurality of sensing results, the central device may perform a fusing operation on the sensing results, and output the fused sensing result to the GPT device, thus, the fused sensing result is comprehensive, thereby improving the accuracy of the fused sensing result.

In a possible implementation, the at least two sensing results include at least two matching scores or at least two distances, the central device obtains the fused sensing result by fusing, according to the at least two matching scores or the at least two distances, part or all of the at least two sensing results from the at least two sensing devices. For example, the matching score of each sensing result may be regarded as a weight of each sensing result when fusing the plurality of sensing results. For another example, the matching score of each sensing result may be regarded as a criterion for selecting the sensing results to fuse. It should be noted that, there may be other examples for use of the matching score or the distance, which is not limited here. During the fusing operation on the sensing results, by considering the matching score or the distance of each sensing result which may indicate the relevance between the sensing result and the first query information, the at least two sensing results are fused according to the at least two matching scores or the at least two distances, for example, in which the sensing result with the higher matching score or with the smaller distance would be given higher importance in the fusion, thus the impact of some sensing results with lower reliability may be reduced, the accuracy of the fused sensing result is thus further improved, and the reliability of the fused sensing result is ensured.

In a possible implementation, the central device determines a second matching score between the fused sensing result and the first query information, or, determines a second distance between the fused sensing result and the first query information. The second matching score or the second distance may indicate the relevance between the fused sensing result and the first query information, that is, the second matching score or the second distance may be used for evaluating the reliability of the fused sensing result.

In a possible implementation, the scoring function includes an inner product, the central device divides the first query information into a plurality of sub-blocks, transmits a first sub-block among the plurality of sub-blocks to the sensing device; stops a transmission of a second sub-block among the plurality of sub-blocks other than the first sub-block when determining a number of a certain sensing device among the plurality of sensing devices is greater than or equal to a third threshold, where the second matching score for the certain sensing device is greater than or equal to a fourth threshold or the second distance for the certain sensing device is less than or equal to a fifth threshold; and continues the transmission of the second sub-block when determining the number is less than the third threshold. In some cases, it may be unnecessary to transmit all the first query information to the sensing device, if part of the first query information is enough for obtaining a reliable sensing result. The number of the certain sensing device whose second matching score is greater than or equal to a fourth threshold or whose second distance is less than or equal to a fifth threshold, is greater than or equal to a third threshold, which ensures the reliability of the fused sensing result. By dividing the first query information into a plurality of sub-blocks, and transmitting a sub-block each time, in the case that the reliability of the fused sensing result is ensured, the transmission of the sub-block is stopped, that is, if there are sufficient number of the sensing devices who feedback their sensing result and the fused sensing result reaches a certain level of relevance (or reliability), the central device may not continue to transmit the second sub-block, the amount of data transmission is thus reduced.

In order to elaborate the communication methods of the present disclosure more clearly, in the following, taking the communication system including at least a central device, a plurality of distributed sensing devices and at least a GPT device as an example, the method will be described in more details with the following example embodiments.

### Embodiment 1

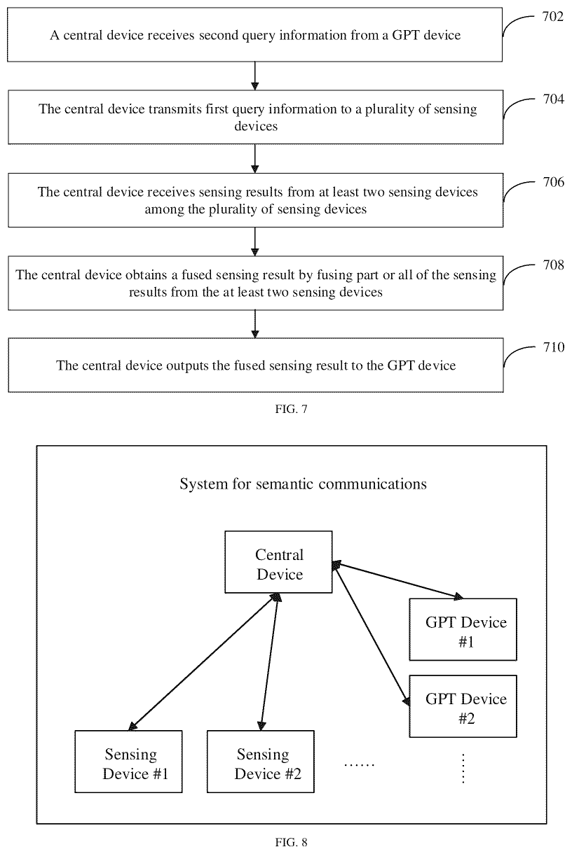

In the present disclosure, the wireless system is also called a communication system, or a wireless communication system. Herein the wireless system comprises a plurality of devices, for example, the plurality of devices comprise at least a central device, a plurality of distributed sensing devices and at least a GPT device (in FIG. 8).

The GPT device is responsible for encoding or decoding query messages and sensed data. In details, it generates a query message that contains one goal or more goals in natural language for the central device; the central device semantizes the query message into a semantic vector (i.e., the foregoing mentioned query semantic), tokenizes the semantic vector into a goal semantic token (or vector) (i.e., the foregoing mentioned query token), and then broadcasts the goal semantic token to the sensing devices. A sensing device, triggered by receiving the goal semantic token, measures its sensed data and converts the sensed data into a sensed semantic token (i.e., the foregoing mentioned sensing token). The sensing device compares and scores the relevance between the goal semantic token and the sensed semantic token, and transmits the sensed data in semantic vector only if the score of relevance is higher than a threshold. The central device fuses the sensed data in semantic vectors, and outputs the fused one to the GPT device that will generate the next query message based on the fused input.

A central device may be a BS, e.g., gNB, or eNB etc., or the central device may be an access point (AP).

A sensing device is responsible for measuring and/or collecting local physical-world data. It may be sensing UE, sensing equipment, IoT equipment, UE, mobile phones, handset, or other equipment. The sensing device may be equipped with a sensing gadget or component to measure local physical-world data near it into sensed data; the sensing device encodes and transmits them to the central device.

A GPT device may generate a sequence of the query messages and receive a fused sensing message from the central device. In the present disclosure, the GPT device could be also called an AI agent device, a robot device, or a smart controlling device.

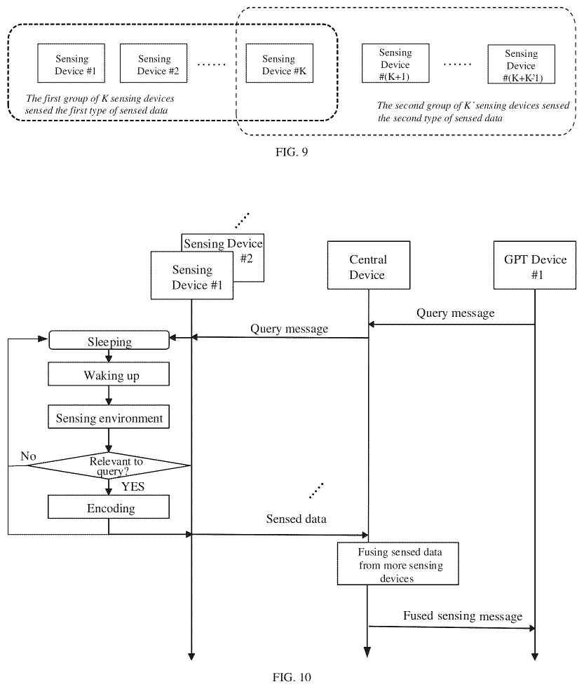

In details, a plurality of the sensing devices herein may be grouped or classified in terms of types of sensed data. The first group of the sensing devices may measure the first type of sensed data (e.g., red, green, blue (RGB) images or video), whereas the second group of sensing devices may measure the second type of sensed data (e.g., Radio RF point-cloud or Lidar Point cloud) as illustrated in FIG. 9. It should be noted that, some sensing devices can be grouped into more than one group, i.e., some sensing devices can measure more than one type of sensed data.

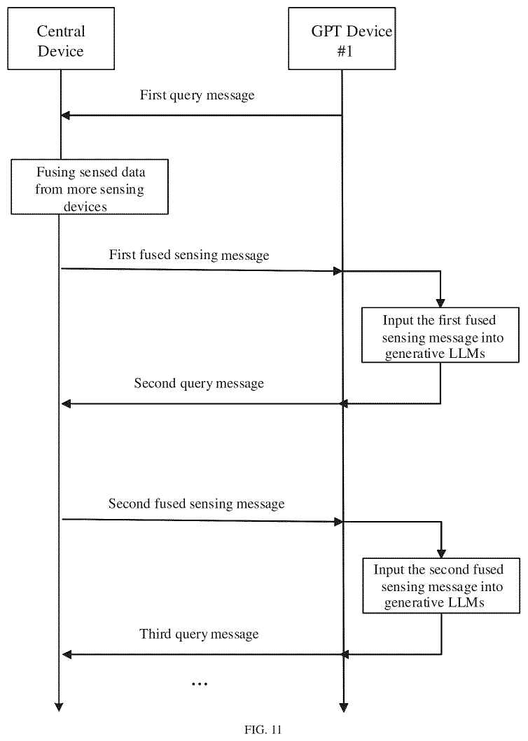

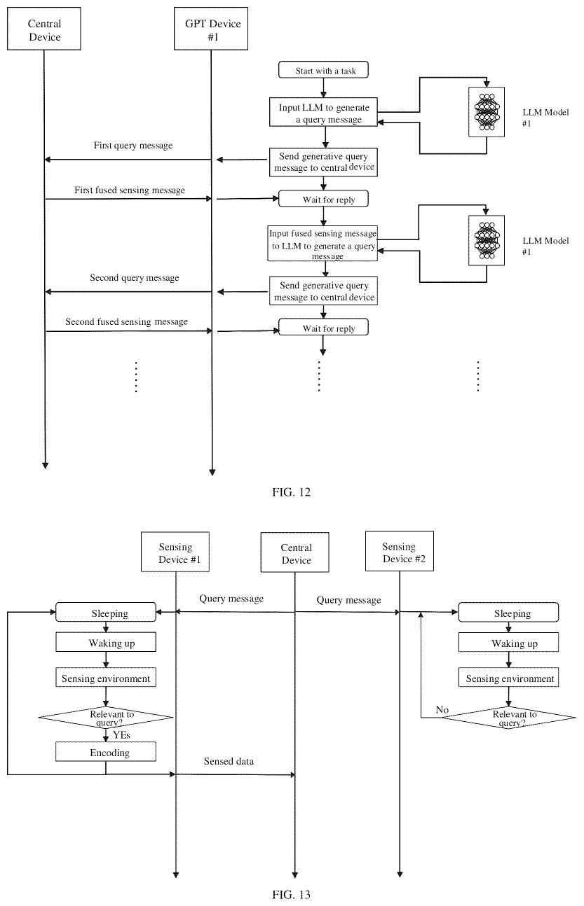

The central device actively requests or triggers the sensing devices to transmit their most recent sensed data (in FIG. 10). Accordingly, the sensing devices will transmit their sensed data.

The central device may transmit the first query message or messages to one or some sensing devices in DL broadcast, multicast, or unicast channel or channels, which may be in physical broadcast channel(s), shared channel, or dedicated channel(s).

After a sensing device receives the first query message, the sensing device decides whether or not to transmit its sensed data. In details, the sensing device decodes the first query message, measures its data, and decides whether or not to transmit its sensed data, which is called as responding to the first query message. If the sensing device decides to respond to the first query message, the sensing device would encode/encapsulate the sensed data into a payload and then transmit it to the central device in UL channel or channel(s), which may be physical UL shared channel or dedicated UL channel.

After the central device of the wireless system receives all the payloads (i.e., the foregoing mentioned sensing results) from the sensing devices that responded to the first query message, the central device may fuse all or some payloads into a fused payload. Optionally, the central device may input the fused payload into the GPT device that may process them and then generate the second query message.

The central device may transmit the second query message or messages to one or some sensing devices in DL broadcast, multicast, or unicast channel or channel(s).

The GPT device transmits the query message(s) to the central device to inform and configure the central device to schedule when, how, what, and which sensing devices to sense and transmit their sensed data to the central device. The GPT device may be implemented/located together with the central device for shorter latency, or the GPT device may be implemented in a remote data center, to which the central device may access via core network, or the GPT device may be on another connected device in the same wireless system of the central device. Please note that, in the present disclosure, the query message from the central device to the sensing device (downlink message) could be carried in higher layer signaling, such as radio resource control (RRC) signaling, or medium access control (MAC) layer signaling. Or, the query message could be carried in physical layer signaling, e.g., downlink control information (DCI). Or the query message is carried in the combination of the higher layer signaling and the physical signaling. It is similar for other downlink messages/data transmitted from the central device to the sensing device. Similarly, in the present disclosure, for uplink messages/data, they could be carried in higher layer signaling, such as RRC signaling, or MAC layer signaling. Or, they could be carried in physical layer signaling, e.g., uplink control information (UCI). Or they could be carried in the combination of the higher layer signaling and the physical signaling. It could be noted that the message in the present disclosure could be replaced with information, which may be carried in one single message, or be carried in more than one separate message.

In the above, the GPT device may generate a query message, and transmit the query message to the central device. In response to the query message from the GPT device, the central device may transmit the query message to a sensing device. In response to the query message from the central device, the sensing device may collect sensed data, and transmit the sensed data to the central device when determining that the sensed data and the query message are matched. It should be noted that, the query message transmitted from the GPT device to the central device is a specific form of the foregoing mentioned second query information, and the query message transmitted from the central device to the sensing device is a specific form of the foregoing mentioned first query information. Further, the first query information and the second query information may include a single query message, or more than one query message. Similarly, the fused sensing message is a specific form of a fused sensing result, and the fused sensing result may include a single fused sensing message, or more than one fused sensing message.

The wireless system comprising a central device, sensing devices, and a GPT device may form a series of interactions, in which the GPT device generates a sequence of the query messages for the sensing devices, the sensing devices collect and feedback the sensed data, and the central device fuses them and input them to the GPT device as illustrated in FIG. 11.

In some circumstances, some sensing devices may actively transmit their sensed data without receiving any query message from the central device. The sensing devices that transmit the sensed data may respond to some urgency queries such as fire alarming or car accidents. In some sense, some query messages have been pre-defined and configured into the system by default.

### Embodiment 2

A GPT device in Embodiment 1 may generate a sequence of the query messages based on the previous sensing messages, wherein the previous sensing messages are received and/or fused by the central device. The GPT device may infer one or several generative AI models. The generative AI model or model inferences deep neural network or networks to output a query message or messages. The GPT device generates a sequence of the query messages, called as “a chain of the thoughts” by interacting with a sequence of the fused sensing messages into which the central device fuses the sensed data transmitted by the responsive sensing devices; as illustrated in FIG. 12.

A query message that the GPT device generates may convey semantic goals, tasks, or objectives. For example, a query message of “localize an incoming pedestrian” explicitly establishes a semantic goal for the sensing devices to focus on its nearby pedestrian and to prevent the sensing devices from being distracted. Since a query message conveys a semantic goal or goals, the query message that the central device transmits to the sensing devices may trigger a goal-oriented sensing task at each responsive sensing device that receives and responds to the very query message. Please note that a message may convey several goals. For example, a message of “find a moving pedestrian with a white coat” conveys two semantic goals or tasks: a moving pedestrian and a pedestrian with a white coat.

In an implementation, the central device may broadcast a sequence of the query messages, because it may be too costly or even forbidden to schedule a sensing device individually in a wireless system comprising such a high density of sensing devices. Therefore, once a sensing device receives a query message, the sensing device may become waken but with little idea whether or not its sensed data is sufficiently relevant to the goal conveyed by the query message. Thereby the sensing device may enable its sensing gadget to sense its nearby environment into sensed data and compare the sensed data with the query message. If the sensing device tells that the sensed data is sufficiently relevant with the query message, the sensing device encodes and transmits the sensed data to the central device (Sensing Device #1 in FIG. 13). Otherwise, the sensing may not respond to the query message at all (Sensing Device #2 in FIG. 13). In this sense, the wireless system doesn't schedule an individual sensing device but schedule a common task across a collectivity of sensing devices.

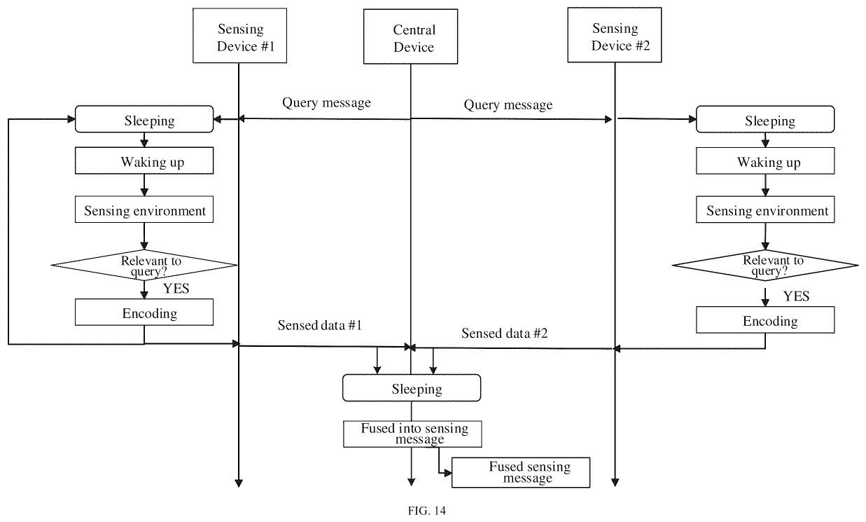

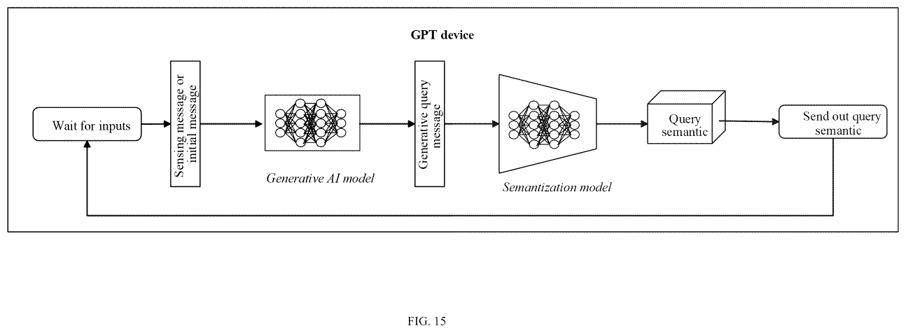

The central device may receive a plurality of sensed data from some or all the sensing devices that respond to the query message at the end of a pre-defined responding timing interval. The central device may fuse all the sensed data into one sensing message and input the sensing message to the GPT device that would generate the next query message based on the sensing message, as shown in FIG. 14.

Because only those sensing devices that respond to the query message would transmit the sensed data, lots of radio resource would be saved in comparison with one-to-one scheduling algorithm.

### Embodiment 3

A sequence of the query messages in Embodiment 2 that the GPT device generates and the central device broadcasts is in a natural language, that is, human-readable. The GPT device may employ an LLM (large-language-model) to infer over a fused sensing message (in a natural language too) input to generate a new query message. The LLM model may be a “standard” foundation model like a transformer, or a “custom” model that is built for a narrower vocabulary and specific scenario. For example, a customized LLM for dealing with industry 4.0 or a customized LLM for dealing with wireless communication signaling and protocols. The GPT device may change, update, downsize, upsize, replace its LLM or LLMs anytime as it wishes. Please note that broadcast, multicast or unicast is allowed.

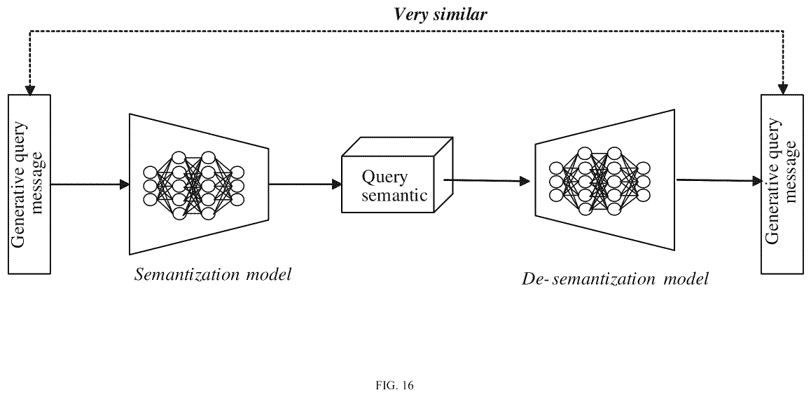

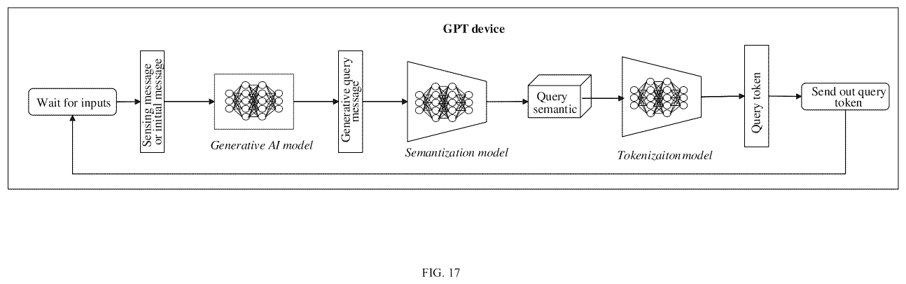

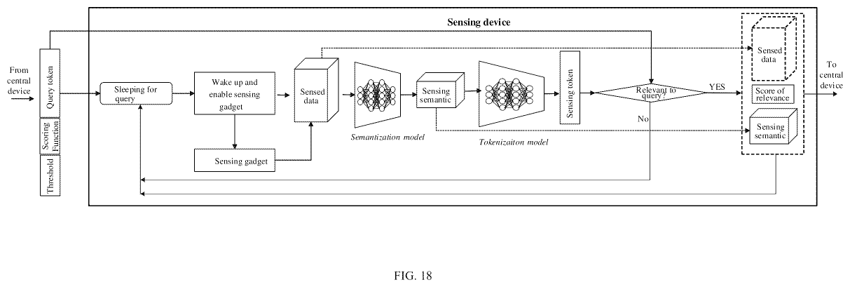

A query message in Embodiment 2 that the GPT device generates is in a natural language. Because of randomness in generating, two different query messages may convey very similar semantic goal or goals. For example, “find a pedestrian” and “localize a walking man” may have the same semantic goal. Therefore, the GPT device may semantize a query message into a query semantic, which is called as “embedding,” “semantization,” “encoding,” “natural-language to machine translation” and so on. The GPT device may translate a query message into a query semantic that may comprise a vector, a matrix, or a tensor of scalars. The translation may be realized by the deep-neural network or other classic functions. A query semantic may preserve all the key semantic goals conveyed by the query message such that the query semantic can be well translated (de-semantized) back to a query message. Optionally, the GPT device may transmit a query semantic instead of a query message to the central device, as illustrated in FIG. 15. As illustrated in FIG. 16, the query semantic is reversible, which means that the query message can be recovered from the query semantic. Please note that if all the LLMs output a common natural language (e.g., English), these LLMs are said to be aligned by the natural language; then whatever LLMs are used, everyone can be smoothly hooked into the GPT device and work well within the wireless system.

In an implementation, the central device may further tokenize a query semantic into a query token. A query token is a fixed-length semantic but comprising a vector of scalars, simpler for transmission and comparison purposes. The wireless system may pre-specify a plurality of lengths for query tokens. Thus, the central device may choose a right token length when tokenizing a query semantic according to the size range of the query semantic. The tokenization can be such a harsh function to prevent a sensing device from recovering a complete query message from a query token. The tokenization may come up with certain privacy protection for query messages. The tokenization may be realized by the deep-neural network or other classic functions; as shown in FIG. 17.

Optionally, the central device receives a query semantic from the GPT device, and then the central device converts the query semantic into a query token with a fixed length; the central device may broadcast the query token with the length to all the sensing devices; the central device may keep the query semantic in its memory or storage to check the feedback sensed data.

As in Embodiment 2, a sensing device may compare its sensed data with the query message; after the sensing device receives a query token (with its length or indicator of its length), the sensing device is waked up to enable its sensing gadget to measure its nearby physical-word environment into sensed data; the sensing device may be equipped with one LLM or more LLMs as a semantization model and input the sensed data into the semantization model to output a sensing semantic; optionally, the sensing device may choose a right length and format of the sensing semantic; and the sensing device may continue to tokenize the sensing semantic into a sensing token with the same length as the query token that the sensing device has received; the sensing device compares or scores the relevance between the query message and sensed data, which is based on what the sensing device has received.

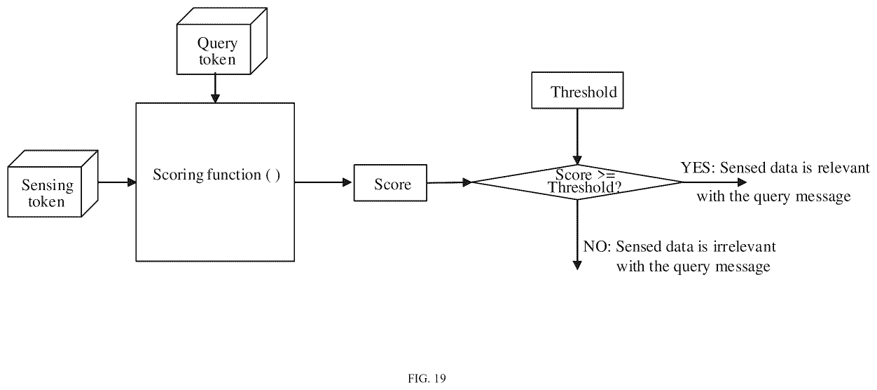

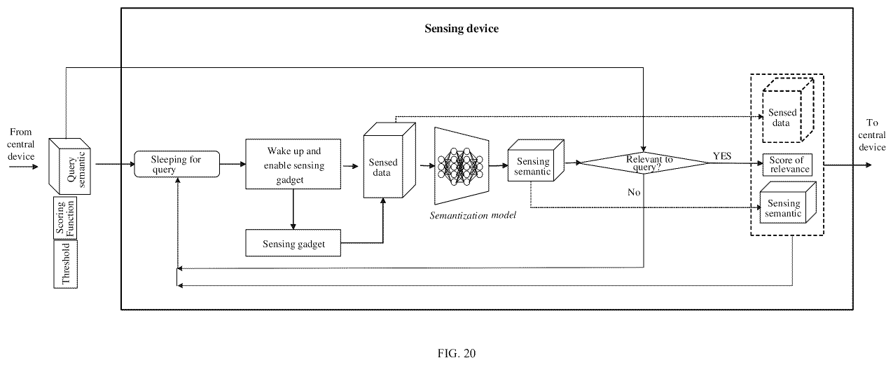

Alternative #1 (FIG. 18 and FIG. 19): the sensing device receives a query token and scoring function; it compares and scores the relevance between the query token and the sensing token; if the score of relevance was greater than or equal to a pre-defined threshold, the sensing device would tell that the sensed data is sufficiently relevant with the query message from the central device.

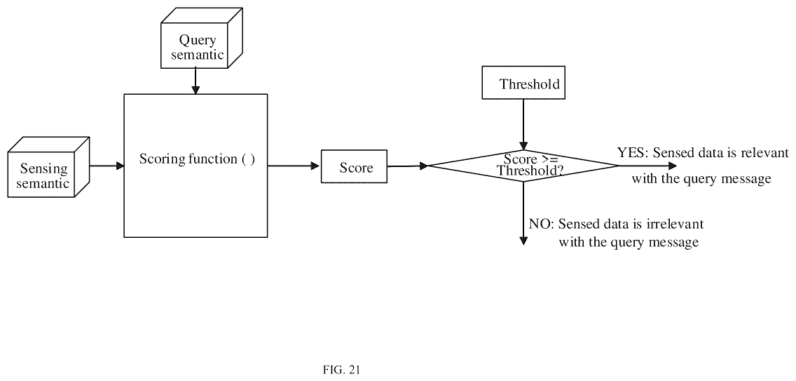

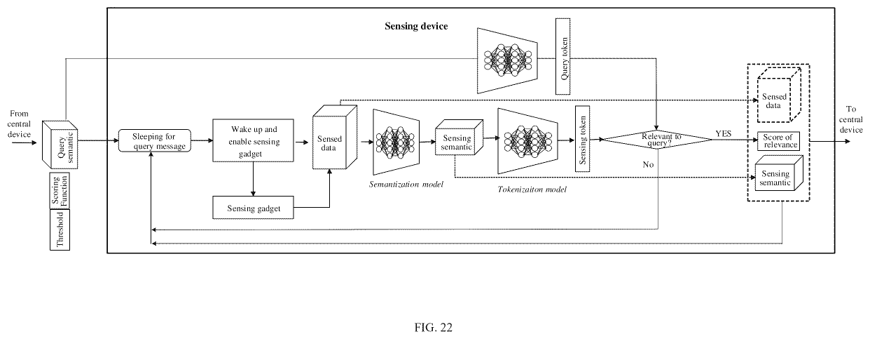

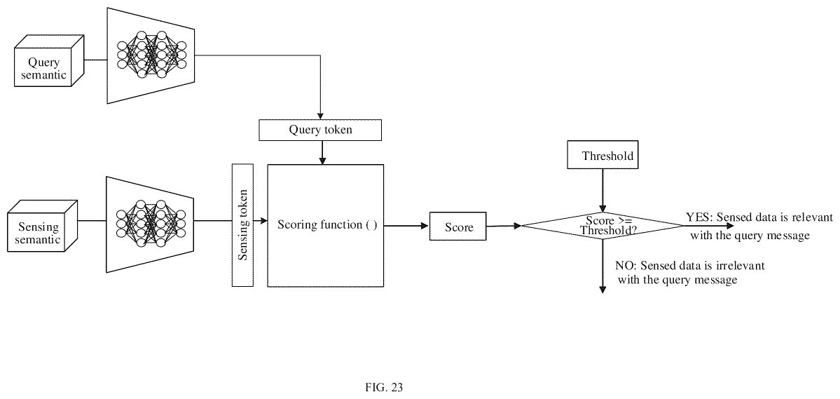

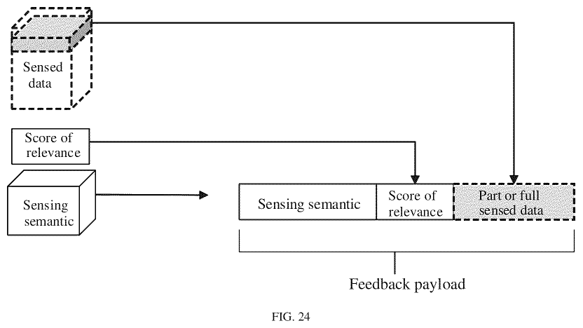

Alternative #2 (FIG. 20 and FIG. 21): the sensing device receives a query semantic and a scoring function; it compares and scores the relevance between the query semantic with the sensing semantic, if both semantics are in a similar size and format; if the score of relevance was greater than or equal to a pre-defined threshold, the sensing device would tell that the sensed data is sufficiently relevant with the query message from the central device.

Alternative #3 (FIG. 22 and FIG. 23): the sensing device receives a query semantic and a scoring function; it firstly converts the query semantic into a query token by the local tokenization model; and it compares and scores the relevance between the query token and sensing token; if the score of relevance was greater than or equal to a pre-defined threshold, the sensing device would tell that the sensed data is sufficiently relevant with the query message from the central device.

If the score of relevance is greater than or equal to a pre-defined threshold, the sensing device may transmit information (i.e., the foregoing mentioned sensing result) comprising the sensed data and the score of relevance to the central device (FIG. 24). The following are some alternatives of the contents in the transmitted information:
Alternative #1: raw sensed data+score of relevance
Alternative #2: sensing semantic+score of relevance
Alternative #3: half raw sensed data (e.g., exact value or number)+sensing semantic+score of relevance.

A sensing device may be equipped with one or several semantization models to generate a sensing semantic from sensed (raw) data, may be equipped with a tokenization model to generate a sensing token from a sensing semantic, and may be configured to have a scoring function; unlike the GPT device, the LLMs, the tokenization model, and the scoring functions that a sensing device may use are configured by the central device; the central device may configure and inform the sensing devices of a common LLMs and/or a tokenization model and a scoring function at all the beginning or on the run.

### Embodiment 4

The scoring function in Embodiment 3 that scores the relevance between a query token and a sensing token can be realized by a scoring function. The scoring function may be an inner product, or a dot product, a euclidean distance, or other scoring functions.

In whichever scoring function is used, the central device has to inform and configure all the sensing devices to use the same scoring function either explicitly or implicitly in order that the scores of relevance in Embodiment 3 from different sensing devices could be comparable at the central device; the central device may configure and inform the sensing devices of a common scoring function at all the beginning in the DL message, or the scoring function or a list of the scoring functions is specified in the structure, or the scoring function is indicated with the query semantic in DL.

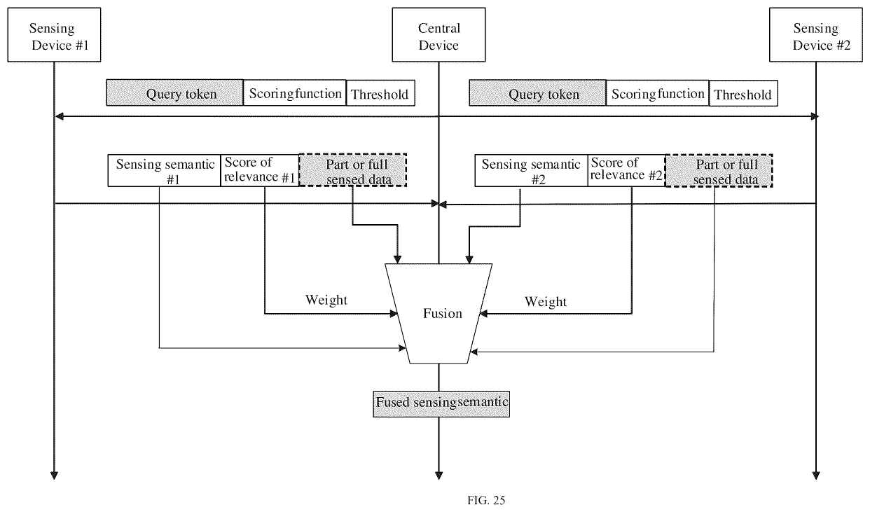

As illustrated in FIG. 25, after the central device receives the sensing semantics and the scores of relevance from the sensing devices that respond to the query token at the end of a response time interval, the central device may fuse the sensing semantics with the scores of relevance, in which the sensing semantics with the higher scores of relevance would be given higher importance in the fusion; a fusion algorithm is open for individual implementation, such as simple, linear, weighted combination, or DNN-based fusion.

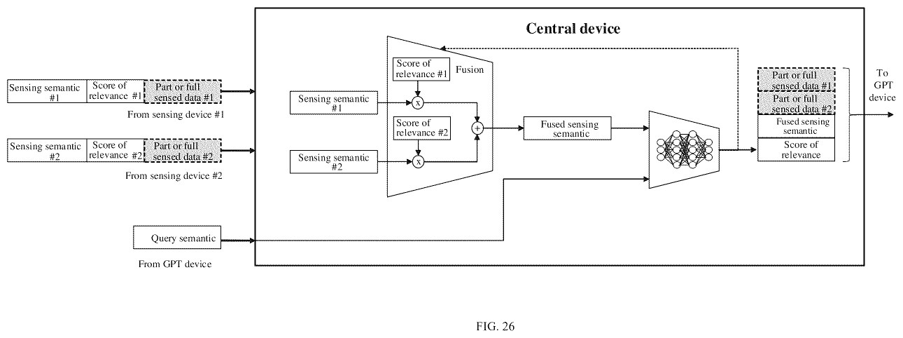

Optionally, as illustrated in FIG. 26, the central device may perform the secondary relevance (reliability) scoring between the query semantic and the fused sensing semantic; usually the central device may use a deep neural network that measures the relevance between the two semantic inputs; in some cases, the central device may perform a message-passing-algorithm with the deep neural network, wherein the scores of relevance that all the responsive sensing devices transmit would be used as initial weights of the fusion, and then the weights would be updated iteratively to maximize the scoring of the relevance (or minimize the distance) between the query semantic and the fused sensing semantic; the central device may send the fused sensing semantic with the reliability score to the GPT device.

The GPT device may de-semantize the fused sensing semantic into a sensing message and then input the sensing message into the LLMs; moreover, the GPT device may record the sequence of the query messages and the sequence of the sensing messages for the human-in-loop purpose (e.g., Reinforcement Learning from Human Feedback).

### Embodiment 5

A plurality of sensing devices, either in one type or in multiple types, may serve one or several tasks simultaneously; in an efficient way, a sensing device may be triggered once to serve as many tasks as possible.

A wireless system may comprise two GPT devices, or one GPT device that can conduct two separated tasks; in the following disclosure, two GPT devices is mentioned as an example. And the two GPT devices may be easily extended to one GPT device with two separated tasks.

Although the two GPT devices have their own separate and independent tasks, the two GPT devices may trigger the same sensing devices simultaneously; for example, a driverless car GPT device and a traffic-light GPT device may trigger the same roadside camera sensing devices; nevertheless, although the same sensing devices may be triggered by two GPT devices at the same time interval, the query message from the first GPT device may be different from the query message from the second GPT device; for example, the driverless car GPT device may broadcast a query message about “moving obstacles” and the traffic-light GPT device may broadcast a query message about “density of vehicles,” both of which may be somehow relevant but not similar.

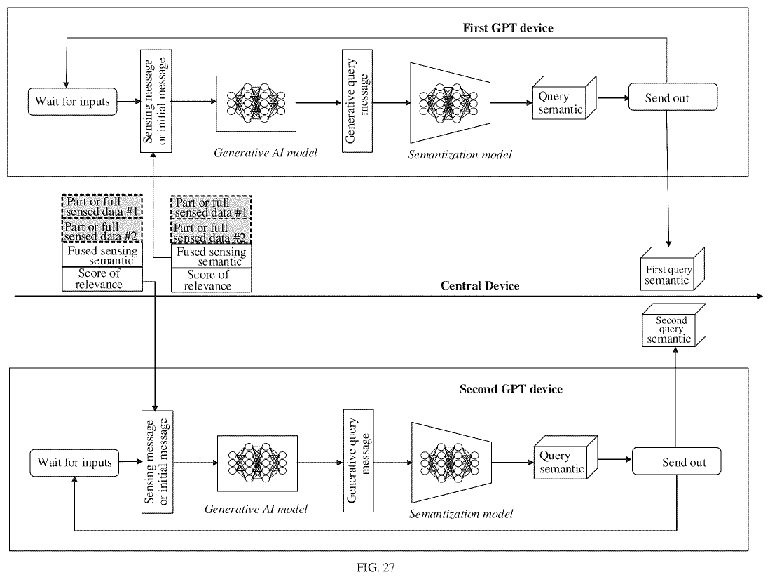

In an example, as illustrated in FIG. 27, the first GPT device generates the first query semantic to the central device and the second GPT device generates the second query semantic to the central device. There are two options shown as follows.

Alternative #1: the central device may tokenize the first query semantic into the first query token and tokenize the second query semantic into the second query token; the central device may use the first tokenization model to tokenize the first query semantic and the second tokenization model to tokenize the second query semantic, or the central device may use a common tokenization model to tokenize the first query semantic and the second query semantic; then the central device may broadcast the first query token, the length of the first query token, the first scoring function related to the first query token, and the first threshold related to the first scoring function, and the second query token, the length of the second query token, the second scoring function related to the second query token, and the second threshold related to the second scoring function in a multiplex way in DL channel(s).

Alternative #2: the central device may not perform the tokenization, and the central device may broadcast the first query semantic, the length and format of the first query semantic, the first scoring function related to the first query semantic, and the first threshold related to the first scoring function, and the second query semantic, the length of the second query semantic, the second scoring function related to the second query semantic, and the second threshold related to the second scoring function in a multiplex way in DL channel(s).

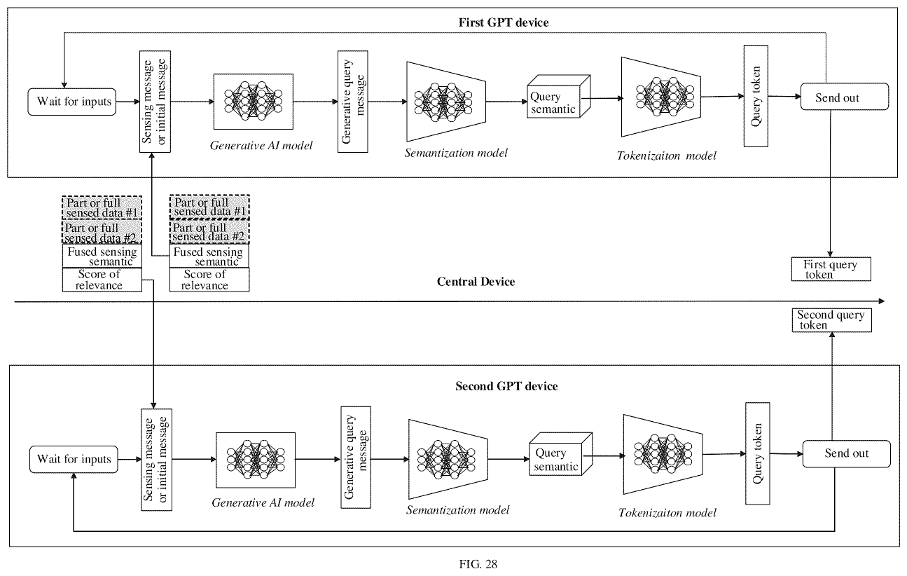

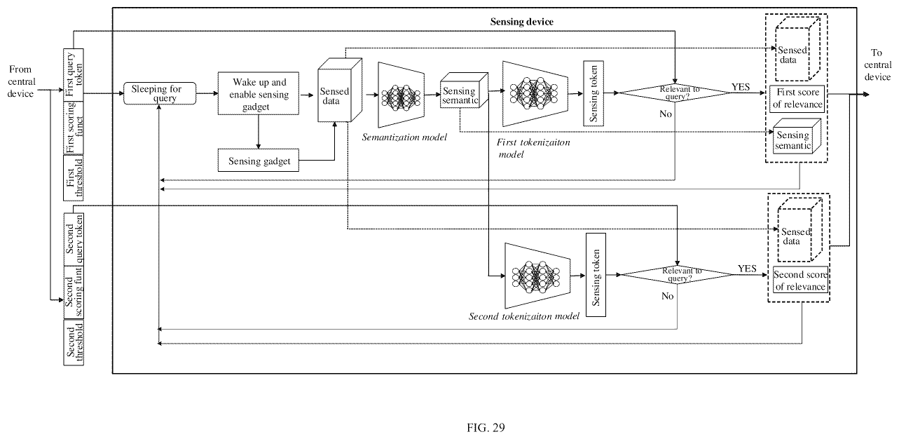

In another example, as illustrated in FIG. 28, the first GPT device generates the first query token to the central device, and the second GPT device generates the second query token to the central device. In this case, the central device may directly transmit the first query token and the second query token to a sensing device. A sensing device may receive both the first query token and the second query token and wakes to enable its sensing gadget to sense the physical-world around itself into sensed data. There are two options shown as follows.

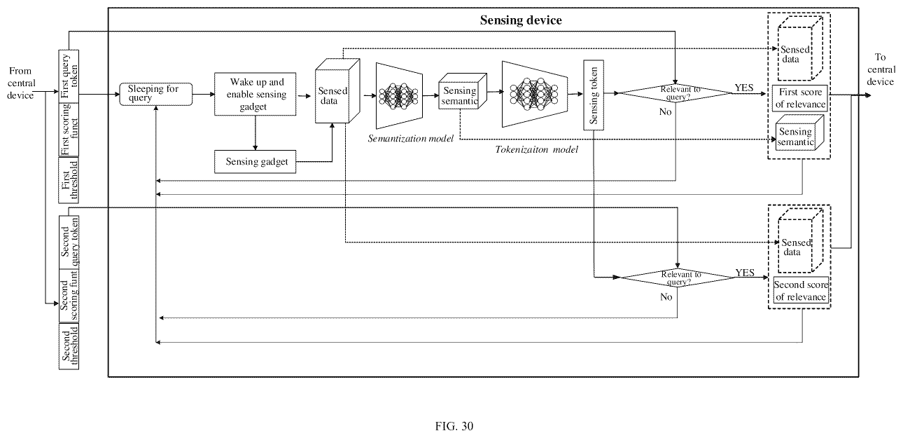

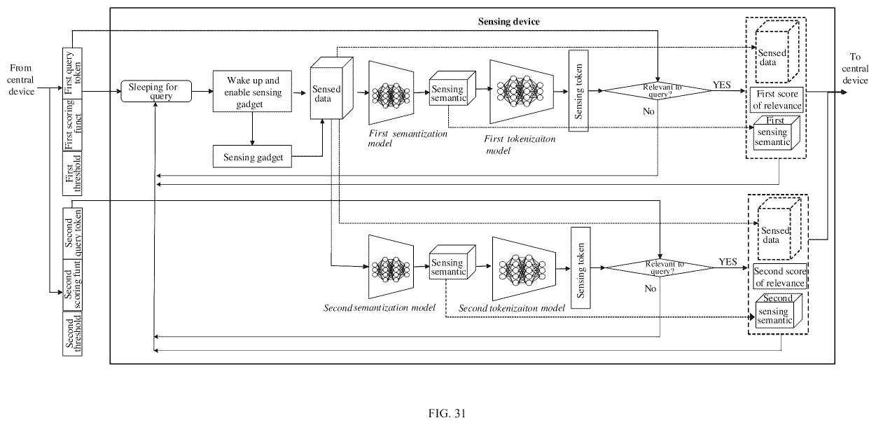

Alternative #1 (FIG. 29 and FIG. 30): the sensing device may convert the sensed data into one common sensing semantic by one LLM or more LLMs; and then the sensing device may tokenize the sensing semantic into the first sensing token in terms of the length of the first query token and tokenize the sensing semantic into the second sensing token in terms of the length of the second query token, in which the sensing device may use the first tokenization model to tokenize the sensing semantic into the first sensing token, and use the second tokenization model to tokenize the sensing semantic into the second sensing token (FIG. 29), or may use a common tokenization model to tokenize the sensing semantic into both the first sensing token and the second sensing token (FIG. 30); the sensing device may score the relevance between the first query token and the first sensing token and the relevance between the second query token and the second sensing token; the sensing device may tell the sensed data provides an enough relevance to the first query token if the first score of the relevance is greater than or equal to the first threshold, and the sensing device may tell the sensed data provides an enough relevance to the second query token if the second score of the relevance is greater than or equal to the second threshold; the sensing device may transmit at least one of the sensed data, the sensing semantic or the first score of relevance (in Embodiment 3) if deciding the first score of relevance is high enough; the sensing device may transmit at least one of the sensed data, the sensing semantic or the second score of relevance (in Embodiment 3) if deciding the second score of relevance is high enough.

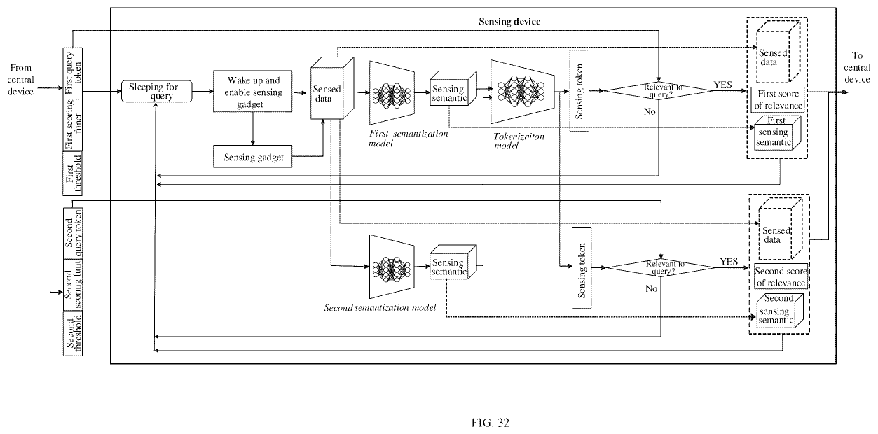

Alternative #2 (FIG. 31 and FIG. 32): the sensing device may convert the sensed data into the first sensing semantic by one LLM or more LLMs and convert the same sensed data into the second sensing semantic by one LLM or more LLMs; and then the sensing device may tokenize the first sensing semantic into the first sensing token in terms of the length of the first query token and tokenize the second sensing semantic into the second sensing token in terms of the length of the second query token, in which the sensing device may use the first tokenization model to tokenize the first sensing semantic into the first sensing token, and use the second tokenization model to tokenize the second sensing semantic into the second sensing token (FIG. 31), or may use a common tokenization model to tokenize the sensing semantic into both the first sensing token and the second sensing token (FIG. 32); the sensing device may score the relevance between the first query token and the first sensing token and the relevance between the second query token and the second sensing token; the sensing device may tell the sensed data provides an enough relevance to the first query token if the first score of the relevance is greater than or equal to the first threshold, and the sensing device may tell the sensed data provides an enough relevance to the second query token if the second score of the relevance is greater than or equal to the second threshold; the sensing device may transmit at least one of the sensed data, the first sensing semantic or the first score of relevance (in Embodiment 3) if deciding the first score of relevance is high enough; the sensing device may transmit at least one of the sensed data, the second sensing semantic or the second score of relevance (in Embodiment 3) if deciding the second score of relevance is high enough.

A sensing device may receive both the first query semantic and the second query semantic and wakes to enable its sensing gadget to sense the physical-world around itself into sensed data. There are several options shown as follows.

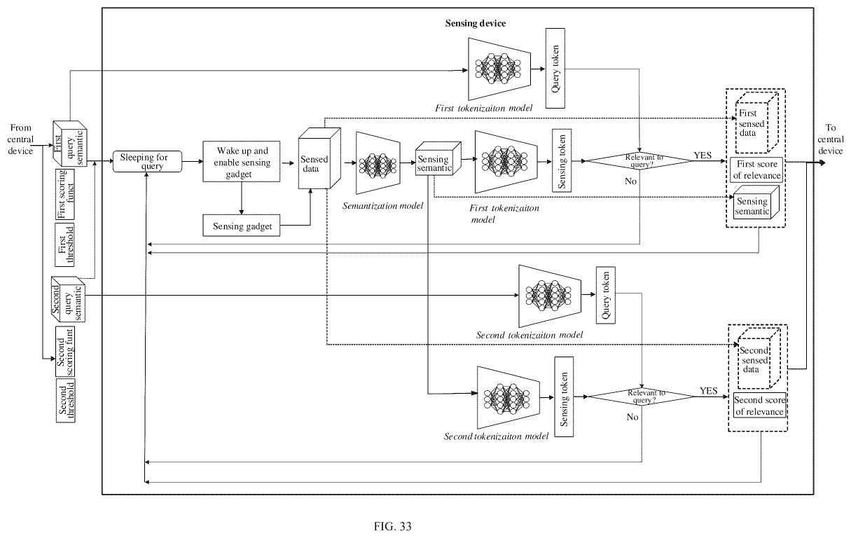

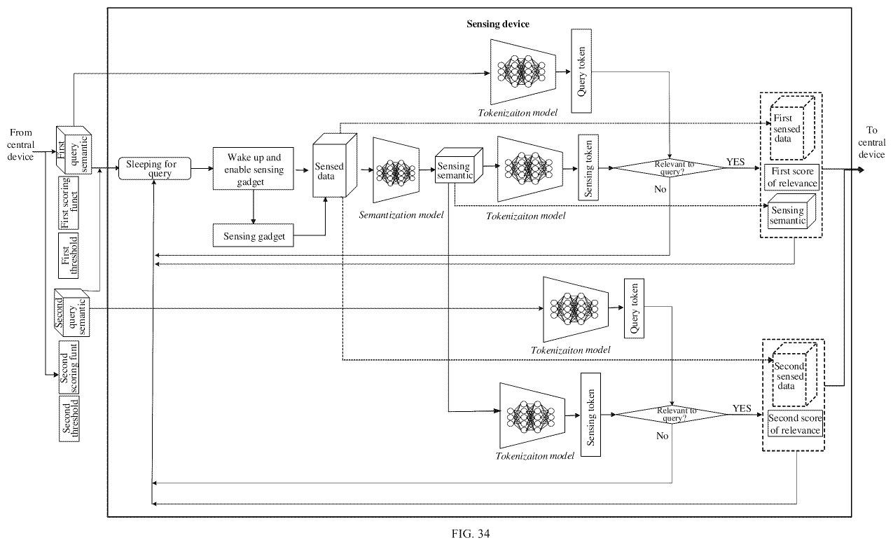

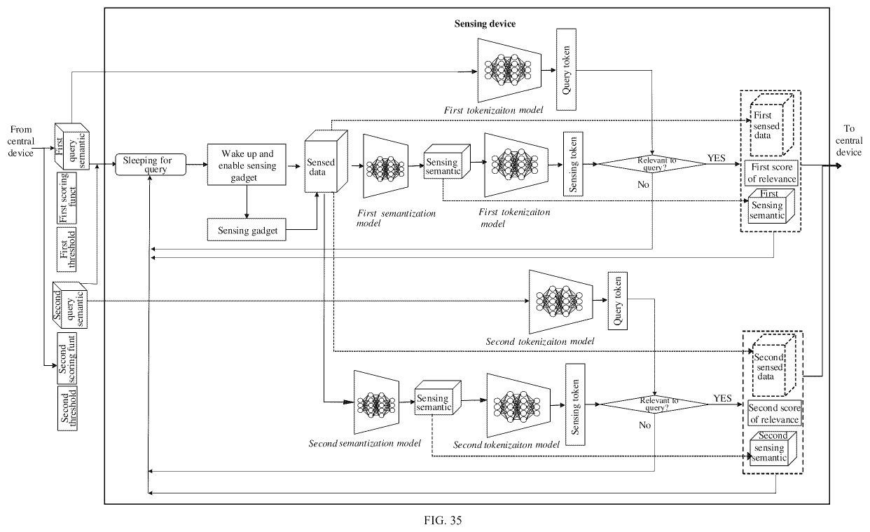

Alternative #1: the sensing device may convert the sensed data into one common sensing semantic by one LLM or more LLMs; and then the sensing device may tokenize the sensing semantic into the first sensing token and the first query semantic into the first query token, both tokens of which are with the same first length that the sensing device decides, while the sensing device may tokenize the sensing semantic into the second sensing token and the second query semantic into the second query token, both tokens of which are with the same second length that the sensing device decides, wherein the sensing device may use the first tokenization model to tokenize the sensing semantic into the first sensing token, and use the second tokenization model to tokenize the sensing semantic into the second sensing token (FIG. 33), or may use a common tokenization model to tokenize the sensing semantic into both the first sensing token and the second sensing token (FIG. 34). It should be noted that, the first query semantic and the second query semantic may be tokenized into the first query token and the second token through the first tokenization model and the second tokenization model respectively, or through a common tokenization model. The sensing device may score the relevance between the first query token and the first sensing token and the relevance between the second query token and the second sensing token; the sensing device may tell the sensed data provides an enough relevance to the first query token if the first score of the relevance is greater than or equal to the first threshold, and the sensing device may tell the sensed data provides an enough relevance to the second query token if the second score of the relevance is greater than or equal to the second threshold; the sensing device may transmit at least one of the sensed data, sensing semantic or the first score of relevance (in Embodiment 3) if deciding the first score of relevance is high enough; the sensing device may transmit at least one of the sensed data, sensing semantic or the second score of relevance (in Embodiment 3) if deciding the second score of relevance is high enough.

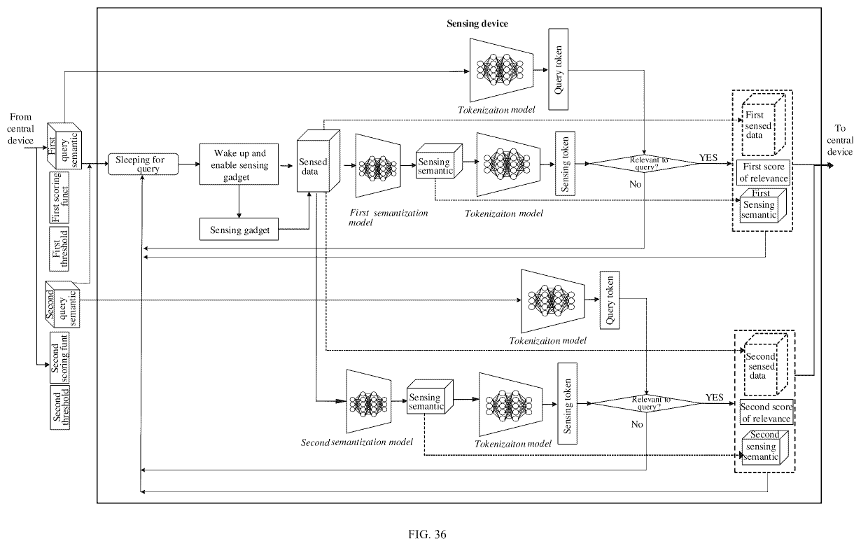

Alternative #2: the sensing device may convert the sensed data into the first sensing semantic by one LLM or more LLMs and convert the same sensed data into the second sensing semantic by one LLM or more LLMs; and tokenize the first sensing semantic into the first sensing token and the first query semantic into the first query token, both tokens of which are with the same first length that the sensing device decides, while the sensing device may tokenize the second sensing semantic into the second sensing token and the second query semantic into the second query token, both tokens of which are with the same second length that the sensing device decides, wherein the sensing device may use the first tokenization model to tokenize the first sensing semantic into the first sensing token, and use the second tokenization model to tokenize the second sensing semantic into the second sensing token (FIG. 35), or may use a common tokenization model (FIG. 36) to tokenize the first and second sensing semantics into both the first sensing token and the second sensing token; the sensing device may score the relevance between the first query token and the first sensing token and the relevance between the second query token and the second sensing token; the sensing device may tell the sensed data provides an enough relevance to the first query token if the first score of the relevance is greater than or equal to the first threshold, and the sensing device may tell the sensed data provides an enough relevance to the second query token if the second score of the relevance is greater than or equal to the second threshold; the sensing device may transmit at least one of the sensed data, the first sensing semantic or the first score of relevance (in Embodiment 3) if deciding the first score of relevance is high enough; the sensing device may transmit at least one of the sensed data, the second sensing semantic or the second score of relevance (in Embodiment 3) if deciding the second score of relevance is high enough.

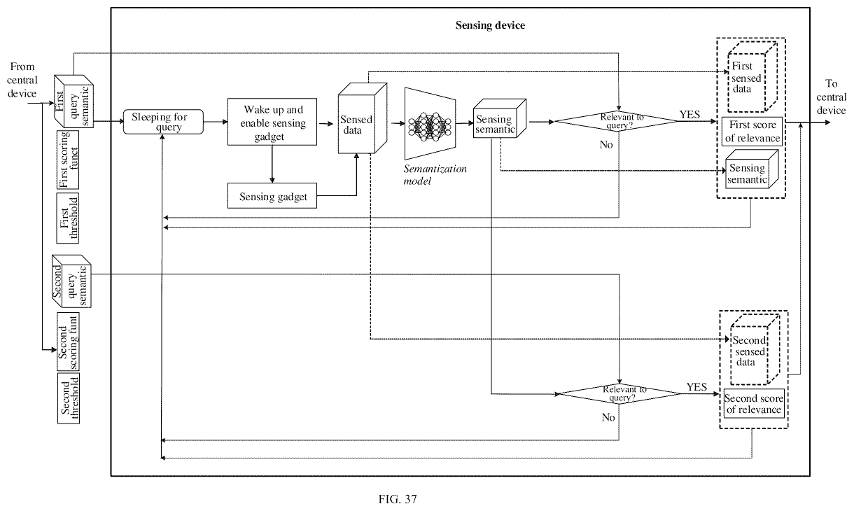

Alternative #3 (FIG. 37): the sensing device may convert the sensed data into one common sensing semantic by one LLM or more LLMs; and then the sensing device may score the relevance between the first query semantic and the sensing semantic and the relevance between the second query semantic and the sensing semantic; the sensing device may tell the sensed data provides an enough relevance to the first query semantic if the first score of the relevance is greater than or equal to the first threshold, and the sensing device may tell the sensed data provides an enough relevance to the second query semantic if the second score of the relevance is greater than or equal to the second threshold; the sensing device may transmit at least one of the sensed data, the sensing semantic or the first score of relevance (in Embodiment 3) if deciding the first score of relevance is high enough; the sensing device may transmit at least one of the sensed data, the sensing semantic or the second score of relevance (in Embodiment 3) if deciding the second score of relevance is high enough.

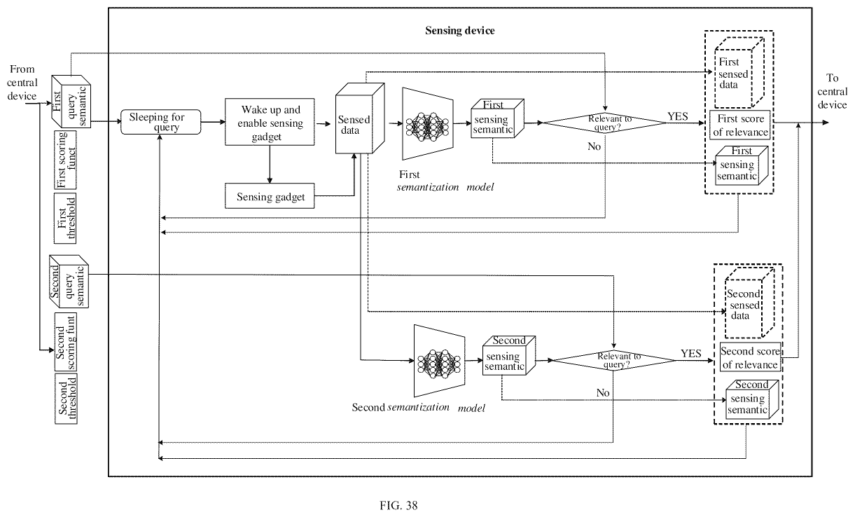

Alternative #4 (FIG. 38): the sensing device may convert the sensed data into the first sensing semantic by one LLM or more LLMs and convert the same sensed data into the second sensing semantic by one LLM or more LLMs; and then the sensing device may score the relevance between the first query semantic and the first sensing semantic and the relevance between the second query semantic and the second sensing semantic; the sensing device may tell the sensed data provides an enough relevance to the first query semantic if the first score of the relevance is greater than or equal to the first threshold, and the sensing device may tell the sensed data provides an enough relevance to the second query semantic if the second score of the relevance is greater than or equal to the second threshold; the sensing device may transmit at least one of the sensed data, the first sensing semantic or the first score of relevance (in Embodiment 3) if deciding the first score of relevance is high enough; the sensing device may transmit at least one of the sensed data, the second sensing semantic or the second score of relevance (in Embodiment 3) if deciding the second score of relevance is high enough.

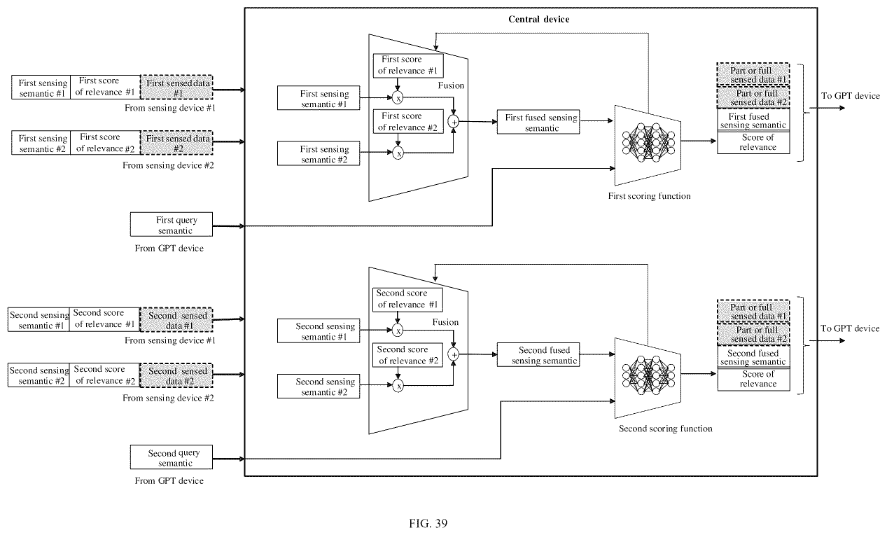

If the central device receives a number of the first sensing semantics plus the first scores of relevance and a number of the second sensing semantics plus the second scores of relevance, the central device may fuse these first sensing semantics according to their first scores of relevance as mentioned in Embodiment 4 into the first fused sensing semantic, and the central device may fuse these second sensing semantics according to their second scores of relevance as mentioned in Embodiment 4 into the second fused sensing semantic; the central device may score the first fused sensing semantic by measuring the relevance between the first fused sensing semantic and the first query semantic as mentioned in Embodiment 4, and score the second fused sensing semantic by measuring the relevance between the second fused sensing semantic and the second query semantic as mentioned in Embodiment 4; the central device may transmit the first fused sensing semantic with the first score of relevance to the first GPT device and transmit the second fused sensing semantic with the second score of relevance to the second GPT device; as shown in FIG. 39.

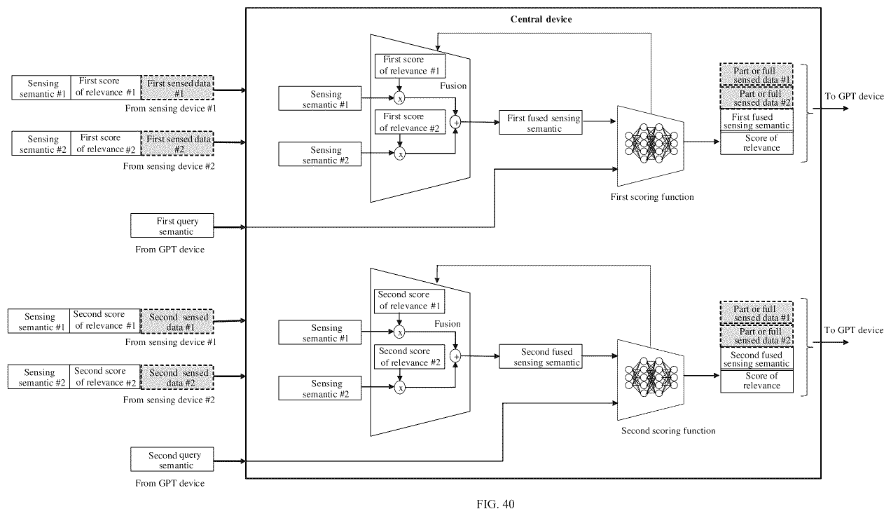

If the central device receives a number of the sensing semantics plus the first scores of relevance and the second scores of relevance, the central device may fuse these sensing semantics according to their first scores of relevance as mentioned in Embodiment 4 into the first fused sensing semantic, and the central device may fuse these sensing semantics according to their second scores of relevance as mentioned in Embodiment 4 into the second fused sensing semantic; the central device may score the first fused sensing semantic by measuring the relevance between the first fused sensing semantic and the first query semantic as mentioned in Embodiment 4, and score the second fused sensing semantic by measuring the relevance between the second fused sensing semantic and the second query semantic as mentioned in Embodiment 4; the central device may transmit the first fused sensing semantic with the first score of relevance to the first GPT device, and transmit the second fused sensing semantic with the second score of relevance to the second GPT device; as shown in FIG. 40.

The first GPT device may receive the first fused sensing semantic and the first score of relevance to the first query semantic; the first GPT device may de-semantize the first fused sensing semantic into the first sensing message; the first GPT device may input the first sensing message into the LLM(s) to inference to generate the next first query message; optionally, the first GPT device may input the first sensing message plus the first score of relevance to the LLM(s).

The second GPT device may receive the second fused sensing semantic and the second score of relevance to the second query semantic; the second GPT device may de-semantize the second fused sensing semantic into the second sensing message; the second GPT device may input the second sensing message into the LLM(s) to inference to generate the next second query message; optionally, the second GPT device may input the second sensing message plus the second score of relevance to the LLM(s).

Next, example embodiments of products related to the communication methods will be described.

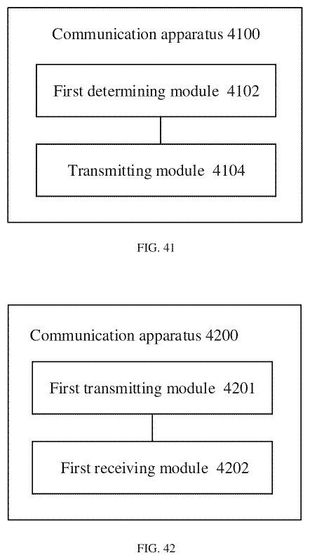

FIG. 41 illustrates a block diagram of a communication apparatus 4100. As shown in FIG. 41, the apparatus 4100 includes:
a first determining module 4102, configured to determine whether sensed data and first query information are matched;
a transmitting module 4104, configured to transmit a sensing result to a central device when the sensed data and the first query information are matched, where the sensing result indicates the sensed data.

In a possible implementation, the apparatus further includes a receiving module, configured to receive the first query information from the central device.

In a possible implementation, the receiving module is specifically configured to receive the first query information broadcasted or multicasted by the central device.

In a possible implementation, the first query information includes a query message; the apparatus further includes a first obtaining module which is configured to obtain the sensed data, and the first determining module is specifically configured to determine whether the sensed data and the query message are matched.

In a possible implementation, the first query information includes a query message; the apparatus further includes a first obtaining module, a first translating module and a second translating module, where the first obtaining module is configured to obtain the sensed data, the first translating module is configured to translate the sensed data into a sensing semantic according to a semantization configuration, the second translating module is configured to translate the query message into a query semantic according to the semantization configuration; and the first determining module is specifically configured to determine whether the sensing semantic and the query semantic are matched.

In a possible implementation, the first query information includes a query semantic; the apparatus further includes a first obtaining module and a first translating module, where the first obtaining module is configured to obtain the sensed data, and the first translating module is configured to translate the sensed data into a sensing semantic according to a semantization configuration; and the first determining module is specifically configured to determine whether the sensing semantic and the query semantic are matched.

In a possible implementation, the first query information includes a query message; the apparatus further includes a first obtaining module, a first translating module, a first tokenizing module, a second translating module and a second tokenizing module, where the first obtaining module is configured to obtain the sensed data, the first translating module is configured to translate the sensed data into a sensing semantic according to a semantization configuration, the first tokenizing module is configured to tokenize the sensing semantic into a sensing token according to a tokenization configuration, the second translating module is configured to translate the query message into a query semantic according to the semantization configuration, and the second tokenizing module is configured to tokenize the query semantic into a query token according to the tokenization configuration; and the first determining module is specifically configured to determine whether the sensing token and the query token are matched.

In a possible implementation, the first query information includes a query semantic; the apparatus further includes a first obtaining module, a first translating module, a first tokenizing module and a second tokenizing module, where the first obtaining module is configured to obtain the sensed data, and the first translating module is configured to translate the sensed data into a sensing semantic according to a semantization configuration, the first tokenizing module is configured to tokenize the sensing semantic into a sensing token according to a tokenization configuration, and the second tokenizing module is configured to tokenize the query semantic into a query token according to the tokenization configuration; and the first determining module is specifically configured to determine whether the sensing token and the query token are matched.

In a possible implementation, the first query information includes a query token; the apparatus further includes a first obtaining module, a first translating module and a first tokenizing module, where the first obtaining module is configured to obtain the sensed data, and the first translating module is configured to translate the sensed data into a sensing semantic according to a semantization configuration, and the first tokenizing module is configured to tokenize the sensing semantic into a sensing token according to a tokenization configuration; and the first determining module is specifically configured to determine whether the sensing token and the query token are matched.

In a possible implementation, the apparatus further includes a second determining module which is configured to determine a semantic length and a semantic format, and the first translating module is specifically configured to: translate the sensed data into the sensing semantic with the semantic length and the semantic format according to the semantization configuration.

In a possible implementation, the apparatus further includes a second obtaining module which is configured to obtain an identifier of the semantization configuration, and the first translating module is specifically configured to: translate the sensed data into the sensing semantic according to the semantization configuration with the obtained identifier.

In a possible implementation, the second obtaining module is specifically configured to: obtain a predefined identifier of the semantization configuration, or receive an identifier of the semantization configuration from the central device.

In a possible implementation, the apparatus further includes a third determining module which is configured to determine a token length according to a length of the query token, and the first tokenizing module is specifically configured to tokenize the sensing semantic into a sensing token with the token length according to the tokenization configuration.

In a possible implementation, the apparatus further includes a third obtaining module which is configured to obtain an identifier of the tokenization configuration, and the first tokenizing module is specifically configured to tokenize the sensing semantic into the sensing token according to the tokenization configuration with the obtained identifier.

In a possible implementation, the third obtaining module is specifically configured to: obtain a predefined identifier of the tokenization configuration, or receive an identifier of the tokenization configuration from the central device.

In a possible implementation, the tokenization configuration includes one of: a tokenization model; a tokenization function; a projection matrix; a graph-based or topology-based pruning; a compression approach.

In a possible implementation, the first determining module is specifically configured to: determine whether a first matching score between the sensed data and the first query information is greater than or equal to a first threshold, or determine whether a first distance between the sensed data and the first query information is less than or equal to a second threshold.

In a possible implementation, the apparatus further includes a fourth obtaining module which is configured to: obtain at least one of a scoring function for determining the first matching score, the first threshold, a function for determining the first distance, or the second threshold.

In a possible implementation, the fourth obtaining module is specifically configured to: obtain at least one of the scoring function for determining the first matching score, the first threshold, the function for determining the first distance, or the second threshold that are predefined, or receive at least one of the scoring function for determining the first matching score, the first threshold, the function for determining the first distance, or the second threshold from the central device.

In a possible implementation, the receiving module is specifically configured to: receive the first query information along with at least one of the scoring function for determining the first matching score, the first threshold, the function for determining the first distance, or the second threshold, from the central device.

In a possible implementation, the scoring function includes an inner product, or a euclidean distance; and the function for determining the first distance comprises an inner product, a cross-correlation matrix, or a cross-entropy function.

In a possible implementation, the sensing result includes one of the following: raw sensed data; a sensing semantic obtained from raw sensed data; half raw sensed data and a sensing semantic obtained from raw sensed data; raw sensed data and a first matching score between the sensed data and the first query information; raw sensed data and a first distance between the sensed data and the first query information; a sensing semantic obtained from raw sensed data and a first matching score between the sensed data and the first query information; a sensing semantic obtained from raw sensed data and a first distance between the sensed data and the first query information; half raw sensed data, a sensing semantic obtained from raw sensed data, and a first matching score between the sensed data and the first query information; half raw sensed data, a sensing semantic obtained from raw sensed data, and a first distance between the sensed data and the first query information.

In a possible implementation, the first query information is carried in higher layer signaling or physical layer signaling or a combination of higher layer signaling and physical signaling, where the higher layer signaling comprises one of radio resource control (RRC) signaling, medium access control (MAC) layer signaling, and the physical layer signaling comprises downlink control information (DCI).

In a possible implementation, the sensing result transmitted to the central device is carried in higher layer signaling or physical layer signaling or a combination of higher layer signaling and physical signaling, where the higher layer signaling comprises one of radio resource control (RRC) signaling, medium access control (MAC) layer signaling, and the physical layer signaling comprises uplink control information (UCI).

In a possible implementation, the transmitting module is specifically configured to: transmit the sensing result to the central device in a physical uplink shared channel or a dedicated uplink channel.

The communication apparatus may be applied to the sensing device as described in the above method examples or may be the sensing device as described in the above method examples. It should be understood by a person skilled in the art that, the relevant description of the modules in the examples of the present disclosure may be understood with reference to the relevant description of the communication method in the examples of the present disclosure.

As illustrated in FIG. 42, the present disclosure provides a communication apparatus 4200 including a first receiving module 4202, configured to receive a sensing result from a sensing device, where sensed data of the sensing device and first query information for the sensing device are matched, and the sensing result indicates the sensed data.

In a possible implementation, the apparatus 4200 further includes a first transmitting module 4201, configured to transmit the first query information to the sensing device.

In a possible implementation, the first transmitting module 4201 is specifically configured to broadcast or multicast the first query information to a plurality of sensing devices.

In a possible implementation, the apparatus further includes a second receiving module and an outputting module, where the second receiving module is configured to receive second query information from a generative pre-trained transformer (GPT) device, and the outputting module is configured to output the sensing result to the GPT device.

In a possible implementation, both the first query information and the second query information include a query message.

In a possible implementation, the second query information includes a query message; the apparatus further includes a translating module which is configured to translate the query message into a query semantic according to a semantization configuration, and the first transmitting module is specifically configured to transmit the query semantic to the sensing device.

In a possible implementation, the second query information includes a query message; the apparatus further includes a translating module and a tokenizing module, where the translating module is configured to translate the query message into a query semantic according to a semantization configuration, the tokenizing module is configured to tokenize the query semantic into a query token according to a tokenization configuration; and the first transmitting module is specifically configured to transmit the query token to the sensing device.

In a possible implementation, the apparatus further includes a first determining module which is configured to determine a semantic length and a semantic format, and the translating module is specifically configured to translate the query message into a query semantic with the semantic length and the semantic format according to the semantization configuration.

In a possible implementation, the apparatus further includes a first obtaining module which is configured to obtain an identifier of the semantization configuration, and the translating module is specifically configured to translate the query message into the query semantic according to the semantization configuration with the obtained identifier.

In a possible implementation, the first obtaining module is specifically configured to: obtain a predefined identifier of the semantization configuration, or receive an identifier of the semantization configuration from the GPT device.

In a possible implementation, both the first query information and the second query information include a query semantic.

In a possible implementation, the second query information includes a query semantic; the apparatus further includes a tokenizing module which is configured to tokenize the query semantic into a query token according to a tokenization configuration, and the first transmitting module is configured to transmit the query token to the sensing device.

In a possible implementation, the apparatus further includes a second determining module which is configured to determine a token length according to a size range of the query semantic, and the tokenizing module is specifically configured to tokenize the query semantic into a query token with the determined token length according to the tokenization configuration.

In a possible implementation, the apparatus further includes a second obtaining module which is configured to obtain an identifier of the tokenization configuration, and the tokenizing module is specifically configured to tokenize the query semantic into the query token according to the tokenization configuration with the obtained identifier.

In a possible implementation, the second obtaining module is specifically configured to obtain a predefined identifier of the tokenization configuration, or receive an identifier of the tokenization configuration from the GPT device.

In a possible implementation, the tokenization configuration includes one of: a tokenization model; a tokenization function; a projection matrix; a graph-based or topology-based pruning; a compression approach.

In a possible implementation, the query semantic includes a query vector, a query matrix or a query tensor of scalars.

In a possible implementation, both the first query information and the second query information include a query token.

In a possible implementation, the apparatus further includes a second transmitting module, configured to: transmit at least one of a scoring function for determining a first matching score between the sensed data and the first query information, a first threshold, a function for determining a first distance between the sensed data and the first query information, or a second threshold, to the sensing device.

In a possible implementation, the first transmitting module is specifically configured to: transmit the first query information along with at least one of a scoring function for determining a first matching score between the sensed data and the first query information, a first threshold, a function for determining a first distance between the sensed data and the first query information, or a second threshold, to the sensing device.

In a possible implementation, the scoring function includes an inner product or a euclidean distance; and the function for determining the first distance includes an inner product, a cross-correlation matrix, or a cross-entropy function.

In a possible implementation, the sensing result includes one of the following: raw sensed data; a sensing semantic obtained from raw sensed data; half raw sensed data and a sensing semantic obtained from raw sensed data; raw sensed data and a first matching score between the sensed data and the first query information; raw sensed data and a first distance between the sensed data and the first query information; a sensing semantic obtained from raw sensed data and a first matching score between the sensed data and the first query information; a sensing semantic obtained from raw sensed data and a first distance between the sensed data and the first query information; half raw sensed data, a sensing semantic obtained from raw sensed data, and a first matching score between the sensed data and the first query information; half raw sensed data, a sensing semantic obtained from raw sensed data, and a first distance between the sensed data and the first query information.

In a possible implementation, the first receiving module is specifically configured to receive at least two sensing results from at least two sensing devices among the plurality of sensing devices, the apparatus further includes a third obtaining module which is configured to obtain a fused sensing result by fusing part or all of the at least two sensing results from the at least two sensing devices, and the outputting module is specifically configured to output the fused sensing result to the GPT device.

In a possible implementation, the at least two sensing results include at least two matching scores or at least two distances; where the third obtaining module is specifically configured to: obtain the fused sensing result by fusing, according to the at least two matching scores or the at least two distances, part or all of the at least two sensing results from the at least two sensing devices.

In a possible implementation, the apparatus further includes a third determining module which is configured to determine a second matching score between the fused sensing result and the first query information, or determine a second distance between the fused sensing result and the first query information.

In a possible implementation, the scoring function includes an inner product; the apparatus further includes a dividing module which is configured to divide the first query information into a plurality of sub-blocks, the first transmitting module is specifically configured to transmit a first sub-block among the plurality of sub-blocks to the sensing device; the apparatus further includes a processing module which is configured to stop a transmission of a second sub-block among the plurality of sub-blocks other than the first sub-block when determining a number of a certain sensing device among the plurality of sensing devices is greater than or equal to a third threshold, where the second matching score for the certain sensing device is greater than or equal to a fourth threshold or the second distance for the certain sensing device is less than or equal to a fifth threshold; and continue the transmission of the second sub-block when determining the number is less than the third threshold.

In a possible implementation, the first query information is carried in higher layer signaling or physical layer signaling or a combination of higher layer signaling and physical signaling, where the higher layer signaling includes one of radio resource control (RRC) signaling, medium access control (MAC) layer signaling, and the physical layer signaling includes downlink control information (DCI).

In a possible implementation, the sensing result received from the sensing device is carried in higher layer signaling or physical layer signaling or a combination of higher layer signaling and physical signaling, where the higher layer signaling includes one of radio resource control (RRC) signaling, medium access control (MAC) layer signaling, and the physical layer signaling includes uplink control information (UCI).

In a possible implementation, the first receiving module is specifically configured to: receive the sensing result from the sensing device in a physical uplink shared channel or a dedicated uplink channel.

The communication apparatus may be applied to the central device as described in the above method examples or may be the central device as described in the above method examples. It should be understood by a person skilled in the art that, the relevant description of the modules in the examples of the present disclosure may be understood with reference to the relevant description of the communication method in the examples of the present disclosure.

The present disclosure provides a sensing device including processing circuitry for executing any of the above communication method. It should be understood that the sensing device can execute the steps performed by the sensing device in the method examples, which will not be repeated here.

The present disclosure provides a central device including processing circuitry for executing any of the above communication method. It should be understood that the central device can execute the steps performed by the central device in the method examples, which will not be repeated here.

The present disclosure provides a communication system, including a central device and a sensing device. The sensing device is configured to execute the steps executed by the sensing device in any of the communication method, and the central device is configured to execute the steps executed by the central device in any of the communication method.

The present disclosure provides a communication system, including a sensing device and at least one of a central device and a GPT device. The sensing device is configured to execute the steps executed by the sensing device in any of the communication method, and the central device/the GPT device is configured to execute the steps executed by the central device in any of the communication method.

The present disclosure provides a chip, including an input/output (I/O) interface and a processor, where the processor is configured to call and run computer execution instructions stored in a memory, to enable a device installing with the chip to execute any of the above communication methods.

The present disclosure provides a computer-readable medium storing computer execution instructions which, when executed by a processor, causes the processor to execute any of the above communication methods.

The present disclosure provides a computer program product including computer execution instructions which, when executed by a processor, causes the processor to execute any of the above communication methods.

The present disclosure provides a computer program including computer execution instructions which, when executed by a processor, causes the processor to execute any of the above communication methods.

Some aspects of the present disclosure relate to a scheme of a semantic-based communication to manage and schedule a large number of sensing devices, in which the sensing devices may belong to different types. The query semantics are goal-oriented and only the sensing device whose sensed data has sufficient relevance with the semantic message(s) would response and transmit their sensed data that are preferably in semantic form too.

Some aspects of the present disclosure relate to a scheme of a collective semantic token-based scheduling over a large number of sensing devices rather than one-to-one individual scheduling.

Some aspects of the present disclosure relate to a scheme of using the large-Language-model (LLM) to turn query and sensed data into a common semantic domain on which they can be easily compared to each other and fused.

The above one or more aspects of the present disclosure may have at least one of the following benefits:
Scheduling may be task-oriented or goal-oriented; only the sensing devices that has contributions to a scheduled task or goal will response and transmit their sensed data;
Privacy may be protected: both the task, goal, or query and sensed data are well protected; no raw data or minimum raw data or message is transmitted over the air;
Forward compatible: semantic-based sensing system in this disclosure may be forward compatible in a sense that any new sensing mechanism can be supported.

In some aspects of the present disclosure, there is provided a computer program comprising instructions. The instructions, when executed by a processor, may cause the processor to implement the method of the present disclosure.

In some aspects of the present disclosure, there is provided a non-transitory computer-readable medium storing instructions, the instructions, when executed by a processor, may cause the processor to implement the method of the present disclosure.

In some aspects of the present disclosure, there is provided an apparatus/chipset system comprising means to implement the method implemented by the sensing device of the present disclosure.

In some aspects of the present disclosure, there is provided an apparatus/chipset system comprising means to implement the method implemented by the central device of the present disclosure.

In some aspects of the present disclosure, there is provided an apparatus/chipset system comprising means to implement the method implemented by the GPT device of the present disclosure.

In some aspects of the present disclosure, there is provided a system comprising at least two of an apparatus in the sensing device of the present disclosure, an apparatus in the central device of the present disclosure and an apparatus in the GPT device of the present disclosure.

In some aspects of the present disclosure, there is provided an apparatus/chipset system comprising at least one processor executing instructions stored in a computer-readable medium to implement the method implemented by the sensing device of the present disclosure.

In some aspects of the present disclosure, there is provided an apparatus/chipset system comprising at least one processor executing instructions stored in a computer-readable medium to implement the method implemented by the central device of the present disclosure.

In some aspects of the present disclosure, there is provided an apparatus/chipset system comprising at least one processor executing instructions stored in a computer-readable medium to implement the method implemented by the GPT device of the present disclosure.

Please note that the different examples may be implemented separately or combined. Although a combination of features is shown in the illustrated embodiments, not all of them need to be combined to realize the benefits of various examples of the present disclosure. In other words, a system or method designed in the present disclosure will not necessarily include all of the features shown in any one of the figures or all of the portions schematically shown in the figures. Moreover, selected features of one example embodiment may be combined with selected features of other example embodiments.

Although this disclosure has been described with reference to illustrative embodiments, the description is not intended to be construed in a limiting sense. Various modifications and combinations of the illustrative embodiments, as well as other examples of the disclosure, will be apparent to persons skilled in the art upon reference to the description. It is therefore intended that the appended claims encompass any such modifications or examples.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B,” as used herein, is interchangeable with the expression “A and/or B.” It refers to a list in which you may select A or B or both A and B. Similarly, “at least one of A, B, or C,” as used herein, is interchangeable with “A and/or B and/or C” or “A, B, and/or C.” It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described examples are to be considered in all respects as being only illustrative and not restrictive. Selected features from one or more of the above-described examples may be combined to create alternative examples not explicitly described, features suitable for such combinations being understood within the scope of this disclosure.

All values and sub-ranges within disclosed ranges are also disclosed. Also, although the systems, devices and processes disclosed and shown herein may include a specific number of elements/components, the systems, devices and assemblies could be modified to include additional or fewer of such elements/components. For example, although any of the elements/components disclosed may be referenced as being singular, the examples disclosed herein could be modified to include a plurality of such elements/components. The subject matter described herein intends to cover and embrace all suitable changes in technology.

Although examples have been described above with reference to the accompanying drawings, those of skill in the art will appreciate that variations and modifications may be made without departing from the scope thereof as defined by the appended claims.

1. A method, comprising:
determining whether sensed data and first query information are matched; and
transmitting a sensing result to a central device in response to that the sensed data and the first query information are matched, wherein the sensing result indicates the sensed data.

2. The method according to claim 1, wherein the first query information comprises a query message, and the method further comprises:
obtaining the sensed data;
translating the sensed data into a sensing semantic according to a semantization configuration; and
translating the query message into a query semantic according to the semantization configuration,
wherein the determining whether the sensed data and the first query information are matched comprises:
determining whether the sensing semantic and the query semantic are matched.

3. The method according to claim 1, wherein the first query information comprises a query semantic, and the method further comprises:
obtaining the sensed data; and
translating the sensed data into a sensing semantic according to a semantization configuration,
wherein the determining whether the sensed data and the first query information are matched comprises:
determining whether the sensing semantic and the query semantic are matched.

4. The method according to claim 1, wherein the first query information comprises a query token, and the method further comprises:
obtaining the sensed data;
translating the sensed data into a sensing semantic according to a semantization configuration; and
tokenizing the sensing semantic into a sensing token according to a tokenization configuration,
wherein the determining whether the sensed data and the first query information are matched comprises:
determining whether the sensing token and the query token are matched.

5. The method according to claim 1, wherein the determining whether the sensed data and the first query information are matched comprises:
determining whether a first matching score between the sensed data and the first query information is greater than or equal to a first threshold; or
determining whether a first distance between the sensed data and the first query information is less than or equal to a second threshold.

6. A method, comprising:
receiving a sensing result from a sensing device, wherein sensed data of the sensing device and first query information for the sensing device are matched, and the sensing result indicates the sensed data.

7. The method according to claim 6, wherein the method further comprises:
receiving second query information from a device that runs at least one artificial intelligence (AI) model; and
outputting the sensing result to the device.

8. The method according to claim 7, wherein the second query information comprises a query message, and the method further comprises:
translating the query message into a query semantic according to a semantization configuration,
wherein the method further comprises:
transmitting the query semantic to the sensing device.

9. The method according to claim 7, wherein the second query information comprises a query message, and the method further comprises:
translating the query message into a query semantic according to a semantization configuration; and
tokenizing the query semantic into a query token according to a tokenization configuration,
wherein the method further comprises:
transmitting the query token to the sensing device.

10. The method according to claim 7, wherein the receiving the sensing result from the sensing device comprises:
receiving at least two sensing results from at least two sensing devices among a plurality of sensing devices,
the method further comprises:
obtaining a fused sensing result by fusing part or all of the at least two sensing results from the at least two sensing devices,
wherein the outputting the sensing result to the device comprises:
outputting the fused sensing result to the device.

11. An apparatus, comprising:
at least one processor coupled with a memory storing instructions that, when executed by the at least one processor, cause the apparatus to perform operations, wherein the operations comprise:
determining whether sensed data and first query information are matched; and
transmitting a sensing result to a central device in response to that the sensed data and the first query information are matched, wherein the sensing result indicates the sensed data.

12. The apparatus according to claim 11, wherein the first query information comprises a query message, and the operations further comprise:
obtaining the sensed data;
translating the sensed data into a sensing semantic according to a semantization configuration; and
translating the query message into a query semantic according to the semantization configuration,
wherein the determining whether the sensed data and the first query information are matched comprises:
determining whether the sensing semantic and the query semantic are matched.

13. The apparatus according to claim 11, wherein the first query information comprises a query semantic,
the operations further comprising:
obtaining the sensed data; and
translating the sensed data into a sensing semantic according to a semantization configuration,
wherein the determining whether the sensed data and the first query information are matched comprises:
determining whether the sensing semantic and the query semantic are matched.

14. The apparatus according to claim 11, wherein the first query information comprises a query token,
the operations further comprising:
obtaining the sensed data;
translating the sensed data into a sensing semantic according to a semantization configuration; and
tokenizing the sensing semantic into a sensing token according to a tokenization configuration,
wherein the determining whether the sensed data and the first query information are matched comprises:
determining whether the sensing token and the query token are matched.

15. The apparatus according to claim 11, wherein the determining whether the sensed data and the first query information are matched comprises:
determining whether a first matching score between the sensed data and the first query information is greater than or equal to a first threshold; or
determining whether a first distance between the sensed data and the first query information is less than or equal to a second threshold.

16. The apparatus according to claim 11, wherein at least one of the first query information or the sensing result is carried in higher layer signaling, physical layer signaling, or a combination of higher layer signaling and physical signaling, wherein the higher layer signaling comprises one of radio resource control (RRC) signaling or medium access control (MAC) layer signaling, and wherein the physical layer signaling comprises downlink control information (DCI) for the first query information, or the physical layer signaling comprises uplink control information (UCI) for the sensing result.

17. An apparatus, comprising:
at least one processor coupled with a memory storing instructions that, when executed by the at least one processor, cause the apparatus to perform operations, wherein the operations comprise:
receiving a sensing result from a sensing device, wherein sensed data of the sensing device and first query information for the sensing device are matched, and the sensing result indicates the sensed data.

18. The apparatus according to claim 17, wherein the operations further comprise:
receiving second query information from a device that runs at least one artificial intelligence (AI) model; and
outputting the sensing result to the device.

19. The apparatus according to claim 18, wherein the second query information comprises a query message, and the operations further comprise:
translating the query message into a query semantic according to a semantization configuration,
wherein the operations further comprise:
transmitting the query semantic to the sensing device.

20. The apparatus according to claim 18, wherein the second query information comprises a query message, and the operations further comprise:
translating the query message into a query semantic according to a semantization configuration; and
tokenizing the query semantic into a query token according to a tokenization configuration,
wherein the operations further comprise:
transmitting the query token to the sensing device.

21. The apparatus according to claim 18, wherein the receiving the sensing result from the sensing device comprises:
receiving at least two sensing results from at least two sensing devices among a plurality of sensing devices,
the operations further comprising:
obtaining a fused sensing result by fusing part or all of the at least two sensing results from the at least two sensing devices,
wherein the outputting the sensing result to the device comprises:
outputting the fused sensing result to the device.

22. The apparatus according to claim 17, wherein at least one of the first query information or the sensing result is carried in higher layer signaling, physical layer signaling, or a combination of higher layer signaling and physical signaling, wherein the higher layer signaling comprises one of radio resource control (RRC) signaling or medium access control (MAC) layer signaling, and wherein the physical layer signaling comprises downlink control information (DCI) for the first query information, or uplink control information (UCI) for the sensing result.
